(19) United States
(12) Patent Application Publication
(10) Pub. No.: US 2013/0191853 A1
(43) Pub. Date: Jul. 25, 2013

(54) PROGRAM EXECUTION METHOD AND PROGRAM EXECUTION APPARATUS

(71) Applicants: Makoto HARADA, Osaka (JP); Kimitaka Nanbu, Osaka (JP); Yasuhiro Yoshida, Kyoto (JP)

(72) Inventors: Makoto HARADA, Osaka (JP); Kimitaka Nanbu, Osaka (JP); Yasuhiro Yoshida, Kyoto (JP)

(21) Appl. No.: 13/558,144

(22) Filed: Jul. 25, 2012

(30) Foreign Application Priority Data
Jan. 20, 2012 (JP) 2012-010477

(51) Int. Cl. G06F 9/46

(52) U.S. Cl. 719/320

(57) ABSTRACT

In a terminal apparatus including a first application that runs on first middleware and a second application that runs on second middleware and performs management of billing, and so on, the second application receives an instruction to execute the first application, obtains billing information of the first application and judges whether or not the first application can be executed, and activates the first application through the second middleware and the first middleware when judging that the execution is possible.

### CROSS REFERENCE TO RELATED APPLICATION

The present application is based on and claims priority of Japanese Patent Application No. 2012-010477 filed on Jan. 20, 2012. The entire disclosure of the above-identified application, including the specification, drawings and claims is incorporated herein by reference in its entirety.

1. Technical Field

The present disclosure relates to a program execution method and apparatus for executing application programs. The present disclosure particularly relates to a technique of controlling execution of application programs on different middleware in an apparatus such as a set top box.

2. Background Art

With set top boxes intended for North American Cable TV, various services such as Video On Demand (VOD) and Pay Per View (PPV) are being implemented in addition to reproducing MPEG-2 streams transmitted from a head end (H/D) and providing an Electronic Program Guide (EPG). Furthermore, with set top boxes that have a hard disk drive (HDD), services such as TSB (Time Shift Buffer, time-shift playback function), TV-program recording, and so on, are also being implemented. There has been an advancement in the adoption of the OpenCable Application Platform (OCAP) Standard (NPL 1) as a Standard for middleware for writing application programs (hereafter also referred to simply as “application(s)”) which implements such services using hardware provided in a set top box. An application running on OCAP middleware (OCAP application) is characterized by being written in Java™, and being capable of running on any set top box as long as it is a OCAP Standard-compliant set top box. It should be noted that “middleware” is software (application platform or execution engine) which runs on an operating system (OS) and performs the activation, termination, and monitoring of an application program.

The OCAP Standard allows the control of hardware such as a tuner, a flash memory, etc., communication with the H/E, AV reproduction, TSB, recording, the displaying of graphics, and so on. By using the graphics display function, game applications, and so on, can also be implemented aside from EPGs.

Furthermore, in the OCAP Standard, it is possible to cause plural applications to run on OCAP middleware. Furthermore, an application can control itself or another application. As a typical practice, plural applications run simultaneously on OCAP middleware, and one of these is an application called a monitor application which is created by a cable service operator. This application performs resource arbitration of hardware for other applications (for example, an application for implementing EPG) and control of other applications.

### CITATION LIST

### Non Patent Literature

[NPL 1] OpenCable Application Platform Specifications (OC-SP-OCAP1.1.3-100603.pdf)

### SUMMARY

### Technical Problem

Using the OCAP Standard, it is possible to create various applications such as game applications, and so on. However, since the environment that a typical developer can create is limited, little development is being done for applications other than those for EPG, VOD, and PPV.

On the other hand, many developers are pursuing the development of applications, and so on, that run on a middleware application engine in the Android™ environment, and new applications are being created on a daily basis.

Furthermore, there are also middleware (execution engines) such as AjaxCE for implementing applications for receiving unique live streaming of respective broadcast operators such as YouTube™, and applications running on such middleware.

In recent years, there is a demand from Cable service operators to incorporate these services other than OCAP to implement services that are more attractive to service subscribers.

For that purpose, there is a need to control an application running on middleware (execution engine) other than OCAP middleware from an OCAP application running on OCAP middleware. However, information necessary for such control, specifically, billing information, rating information, and so on, cannot be obtained, and lifecycle-related control such as appropriate activation and termination was not possible from the OCAP application.

Furthermore, the OCAP application running on OCAP middleware has a unique billing mechanism and also has a unique parental lock mechanism. These mechanisms implemented on OCAP middleware cannot be used from other middleware at present and require unique construction. This results in having multiple billing mechanisms with different payment methods or various parental lock criteria, and is thus extremely troublesome for the Cable service subscriber.

In view of this, the present disclosure has as object to provide a program execution method and program execution apparatus that enables management of a parental lock or billing for an application running on first middleware and an application running on second middleware, through common operation by a user.

### Solution to Problem

In order to achieve the aforementioned object, the program execution method according to an aspect of the present disclosure is a program execution method performed by an apparatus including an operating system, first middleware and second middleware that run on the operating system, a first application program that runs on the first middleware, and a second application program that runs on the second middleware and manages billing or a parental lock, the program executing method including: receiving, by the second application program, an instruction to execute the first application program; obtaining, by the second application program, billing information or parental lock information, the billing information indicating whether or not the first application program is already purchased, and the parental lock information indicating whether or not there is a parental lock for the first application program; judging, by the second application program, whether or not the first application program is executable, based on the obtained billing information or the obtained parental lock information; and activating, by the second application program, the first application program through the second middleware and the first middleware, when it is judged in the judging that the first application program is executable.

With this, the judging for whether or not execution is possible and the activation with respect to a first application program running on the first middleware is performed under the management of a second application program that runs on the second middleware. Therefore, management of billing or parental locks for application programs running on respective different middleware is unified under the management by the second application program. As a result, the user can manage the billing or parental locks for plural application programs running on different middleware through a single unified operation (for example, operation through an OCAP application).

Here, the program execution method according to an aspect of the present disclosure may further include purchasing, by the second application program, the first application program, when it is judged in the judging that the first application program is not executable because the first application program is not yet purchased. Accordingly, when the first application program is not yet purchased, the first application is purchased under the management of the second application program, and thus the user can purchase application programs running on different middleware through a single unified operation (for example, operation through an OCAP application).

Furthermore, in the obtaining, the billing information or the parental lock information may be obtained from a database in which attributes of application programs that run on the first middleware and the second middleware are held in advance, the application programs including the first application program and the second application program. Accordingly, an application program can easily obtain attributes of an application program running on different middleware, by referring to a database in which attributes of applications running on the first middleware and the second middleware are stored, thus facilitating the communalization of billing or parental lock management.

Furthermore, in the obtaining, the billing information or the parental lock information may be obtained by way of the second application program making an inquiry to the first application program and obtaining a reply from the first application program. Accordingly, the second application program obtains the billing information or parental lock information directly from the first application program, thereby eliminating the need to provide a common database for storing the attributes of the respective applications.

Furthermore, it is preferable that in the activating: the second application program notifies the second middleware of information for identifying the first application program that is judged as being executable; and the second middleware identifies the first middleware as middleware on which the first application program runs, based on the information notified from the second application program, and requests the activation of the first application program to the identified first middleware. Accordingly, the first application is reliably activated by the second application program through the second middleware and the first middleware.

In order to achieve the aforementioned object, the program execution apparatus according to an aspect of the present disclosure is a program execution apparatus including: a processor; and programs executed by the processor, the programs including: an operating system; first middleware that runs on the operating system; second middleware that runs on the operating system; a first application program that runs on the first middleware; and a second application program that runs on the second middleware and manages billing and parental lock, wherein the second application program includes: an application list display unit configured to display application programs that run on at least the first middleware, and to receive an instruction to execute the first application program; an application activation judgment unit configured to obtain billing information indicating whether or not the first application program is already purchased or parental lock information indicating whether or not there is a parental lock for the second application program, and to judge whether or not the first application program is executable, based on the obtained billing information or the obtained parental lock information; and an application activation unit configured to activate the first application program through the second middleware and the first middleware, when the application activation judgment unit judges that the application program is executable.

With this, the judging for whether or not execution is possible and the activation with respect to a first application program running on the first middleware is performed under the management of a second application program running on the second middleware. Therefore, management of billing or parental locks for application programs running on respective different middleware is unified under the management by the second application program. As a result, the user can manage the billing or parental locks for plural application programs running on different middleware through a single unified operation (for example, operation through an OCAP application).

Here, the program execution apparatus according to an aspect of the present disclosure may further include a purchasing unit configured to purchase the first application program when the application activation judgment unit judges that the first application program is not executable because the first application program is not yet purchased. Accordingly, when the first application program is not yet purchased, the first application is purchased under the management of the second application program, and thus the user can purchase application programs running on different middleware through a single unified operation (for example, operation through an OCAP application).

It should be noted that the present disclosure can be implemented not only as a program execution method and program execution apparatus such as those described above, but also as the second application program, a non-transitory computer-readable recording medium such as a CD-ROM, and as information, data, or a signal representing the program. In addition, the program, information, data, and signal may be distributed via a communication network such as the Internet.

As described above, according to the present disclosure, a first application running on middleware that is different from middleware that is a platform of a second application can be appropriately controlled from the second application. Therefore, the purchase information of applications purchased by the user and the parental lock information set by the user are unified, and thus user operations for the purchase and parental locks of plural applications running on different middleware is communalized, thereby resolving troublesome operations.

Furthermore, since the purchasing of the first application is performed by the second application particularly when it is judged that the first application is not yet purchased and therefore cannot be executed, the purchasing process of applications is unified, thus resolving troublesome user operations related to application purchasing.

### BRIEF DESCRIPTION OF DRAWINGS

These and other objects, advantages and features of the disclosure will become apparent from the following description thereof taken in conjunction with the accompanying drawings that illustrate a specific example of the present disclosure. In the Drawings:

FIG. 1 is a configuration diagram of a cable television system according to the present disclosure;

FIG. 2 is a diagram showing an example of the usage of a frequency band used in communications between the head end and the terminal apparatuses, in the cable television system according to the present disclosure;

FIG. 3 is a diagram showing an example of the usage of a frequency band (Out Of Band) used in communications between the head end and the terminal apparatuses, in the cable television system according to the present disclosure;

FIG. 4 is a diagram showing an example of the usage of a frequency band (In-Band) used in communications between the head end and the terminal apparatuses, in the cable television system according to the present disclosure;

FIG. 5 is a configuration diagram of the terminal apparatus in the cable television system according to the present disclosure;

FIG. 6 is a diagram showing an example of the appearance of the terminal apparatus in the cable television system according to the present disclosure;

FIG. 7 is a diagram showing the hardware configuration of a CableCard according to the present disclosure;

FIG. 8 is a diagram showing the programs stored by the CableCard according to the present disclosure;

FIG. 9 is a configuration diagram of a packet defined in the MPEG Standard;

FIG. 10 is a diagram showing an example of an MPEG-2 transport stream;

FIG. 11 is a diagram showing an example of an external view in the case where an input unit is made up of a front panel;

FIG. 12 is a configuration diagram of a display compositing unit according to the present disclosure;

FIG. 13 is a diagram showing the programs stored by a terminal apparatus according to the present disclosure;

(a) in FIG. 14 is a diagram showing an example of a screen-display of the display according to the present disclosure, (b) in FIG. 14 is a diagram showing an example of a screen-display of the display according to the present disclosure;

FIG. 15 is a diagram showing an example of information stored in a secondary storage unit according to the present disclosure;

FIG. 16 is a diagram showing an example of information stored in a primary storage unit according to the present disclosure;

FIG. 17 is a schematic diagram showing details of a PAT stipulated by the MPEG-2 Standard;

FIG. 18 is a schematic diagram showing details of a PMT stipulated by the MPEG-2 Standard;

FIG. 19 is a schematic diagram showing details of an AIT stipulated by the DVB-MHP Standard;

FIG. 20 is a schematic diagram showing a file system sent using the DSMCC method;

FIG. 21 is a schematic diagram showing details of an XAIT;

FIG. 22 is a diagram showing an example of information stored in the secondary storage unit according to the present disclosure;

FIG. 23 is a configuration diagram of an application control unit according to the present disclosure;

FIG. 24 is a diagram showing an example of the class configuration of an External AM according to the present disclosure;

FIG. 25 is a flowchart showing the sequence for displaying a list of applications according to the present disclosure;

FIG. 26 is a diagram showing an example of the application list display according to the present disclosure;

FIG. 27 is a diagram showing an example of a filtering condition list display at the time of application selection according to the present disclosure;

FIG. 28 is a diagram showing an example of a filtering condition setting screen according to the present disclosure;

FIG. 29 is a flowchart showing the sequence for activating an external application according to the present disclosure;

FIG. 30 is a diagram for describing the activation sequence in FIG. 29;

FIG. 31 is a flowchart showing the sequence for the purchasing process for the external application according to the present disclosure;

FIG. 32 is a diagram showing a purchasing screen for the external application according to the present disclosure;

FIG. 33 is a configuration diagram of the application control unit including a parental lock information management unit according to the present disclosure;

FIG. 34 is a diagram showing an example of the application list display according to the present disclosure; and

FIG. 35 is a flowchart showing the sequence for activating the external application according to the present disclosure.

### DETAILED DESCRIPTION

Hereinafter, the example of the present disclosure shall be described in detail with reference to the Drawings. It should be noted that the example described below illustrates a preferable specific example. The numerical values, shapes, materials, structural elements, the arrangement and connection of the structural elements, steps, the processing order of the steps etc. shown in the following exemplary example are mere examples, and are not intended to limit the scope of the present disclosure. The scope of the present disclosure is defined solely by the appended Claims. Therefore, among the structural elements in the following exemplary example, structural elements not recited in any one of the independent claims defining the most generic part of the present disclosure are not necessarily required to achieve the object of the present disclosure, but are described as structural elements of a more preferable example.

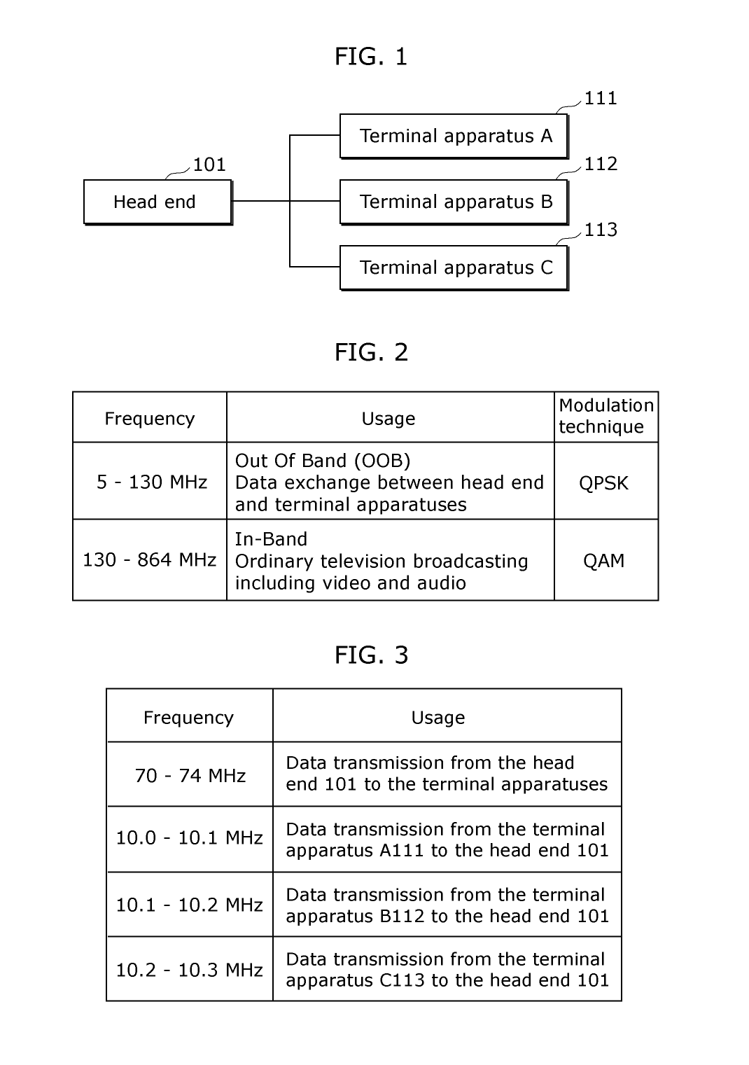

A cable television system according to the example of the present disclosure shall be described with reference to the Drawings. FIG. 1 is a block diagram showing the relationship of apparatuses included in the cable system. The cable system includes a head end 101 and three terminal apparatuses, namely, a terminal apparatus A111, a terminal apparatus B112, and a terminal apparatus C113. It should be noted that, in this example, although three terminal apparatuses are connected to a single head end, the present disclosure can be implemented even when an arbitrary number of terminal apparatuses are connected to the head end.

The head end 101 sends a broadcast signal for video, audio, data, and the like, to a plurality of terminal apparatuses, and receives data transmissions from the terminal apparatuses. In order to realize this, a frequency band is divided for use in transmissions between the head end 101, and the terminal apparatus A111, the terminal apparatus B112, and the terminal apparatus C113.

FIG. 2 is a table showing an example of the division of a frequency band. The frequency band is roughly divided into two types: Out Of Band (abbr. OOB) and In-Band. 5 MHz to 130 MHz is assigned as OOB, and is mainly used in data exchange between the head end 101 and the terminal apparatus A111, the terminal apparatus B112, and the terminal apparatus C113. 130 MHz to 864 MHz is assigned as In-Band, and is mainly used for broadcast channels including video and audio. QPSK modulation format is used with OOB, and QAM64 modulation format is used with In-Band. It should be noted that modulation format technology is generally known and of little concern to the present disclosure, and therefore detailed descriptions are omitted.

FIG. 3 is an example of a more detailed use of the OOB frequency band. 70 MHz to 74 MHz is used in data sending from the head end 101, and all of the terminal apparatus A111, the terminal apparatus B112, and the terminal apparatus C113 receive the same data from the head end 101. On the other hand, 10.0 MHz to 10.1 MHz is used in data sending from the terminal apparatus A111 to the head end 101; 10.1 MHz to 10.2 MHz is used in data sending from the terminal apparatus B112 to the head end 101; and 10.2 MHz to 10.3 MHz is used in data sending from the terminal apparatus C113 to the head end 101. With this, it is possible to send data unique to each terminal apparatus from each terminal apparatus A111, B112, and C113 to the head end 101.

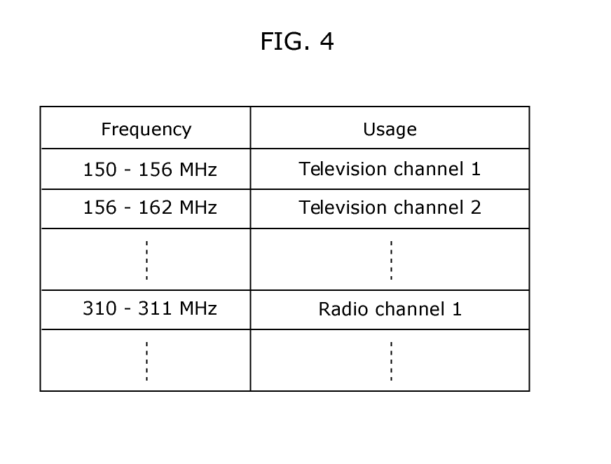

FIG. 4 is a table showing an example of use of an In-Band frequency band 150 MHz to 156 MHz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz onwards. Each of these channels may be used as analog broadcast or as digital broadcast. Digital broadcast is sent in the transport packet format based on the MPEG-2 Specification, and data for various data broadcasts can be transmitted, in addition to audio and video.

The head end 101 is equipped with a QPSK modulation unit, a QAM modulation unit, and the like in for sending the appropriate broadcast signal to the respective frequency bands. In addition, the head end 101 has a QPSK demodulator for receiving data from the terminal apparatuses. Furthermore, the head end 101 can be thought of as having various devices related to such modulation units and demodulation unit. However, the present disclosure relates mainly to the terminal apparatuses, and therefore detailed descriptions are omitted.

The terminal apparatus A111, the terminal apparatus B112, and the terminal apparatus C113 receive and reproduce broadcast signals from the head end 101. Furthermore, the terminal apparatus A111, the terminal apparatus B112, and the terminal apparatus C113 transmit data unique to each terminal apparatus to the head end 101. In this example, the three of the terminal apparatuses A111, B112, and C113 adopt the same configuration.

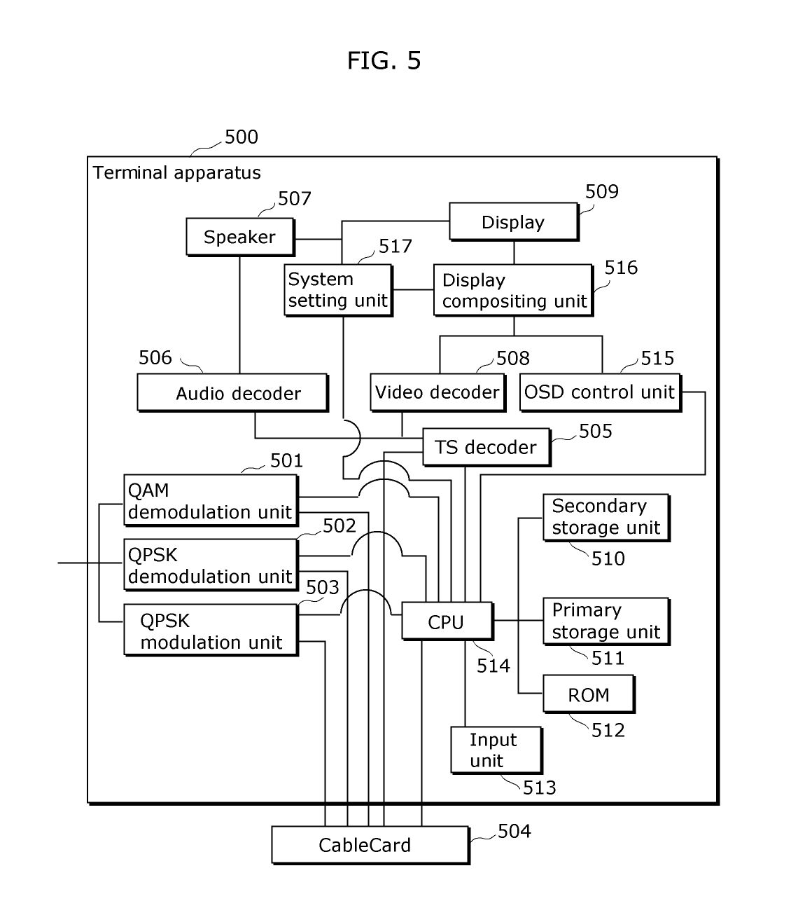

FIG. 5 is a block diagram showing a hardware configuration of the respective terminal apparatuses A111, B111, and C113 (represented here by reference sign 500). A terminal apparatus 500 includes a QAM demodulation unit 501, a QPSK demodulation unit 502, a QPSK modulation unit 503, a TS decoder 505, an audio decoder 506, a speaker 507, a video decoder 508, a display 509, a secondary storage unit 510, a primary storage unit 511, a ROM 512, an input unit 513, a CPU (or processor) 514, an OSD control unit 515, a display compositing unit 516, and a system setting unit 517. Furthermore, a CableCard 504 can be attached to/detached from the terminal apparatus 500.

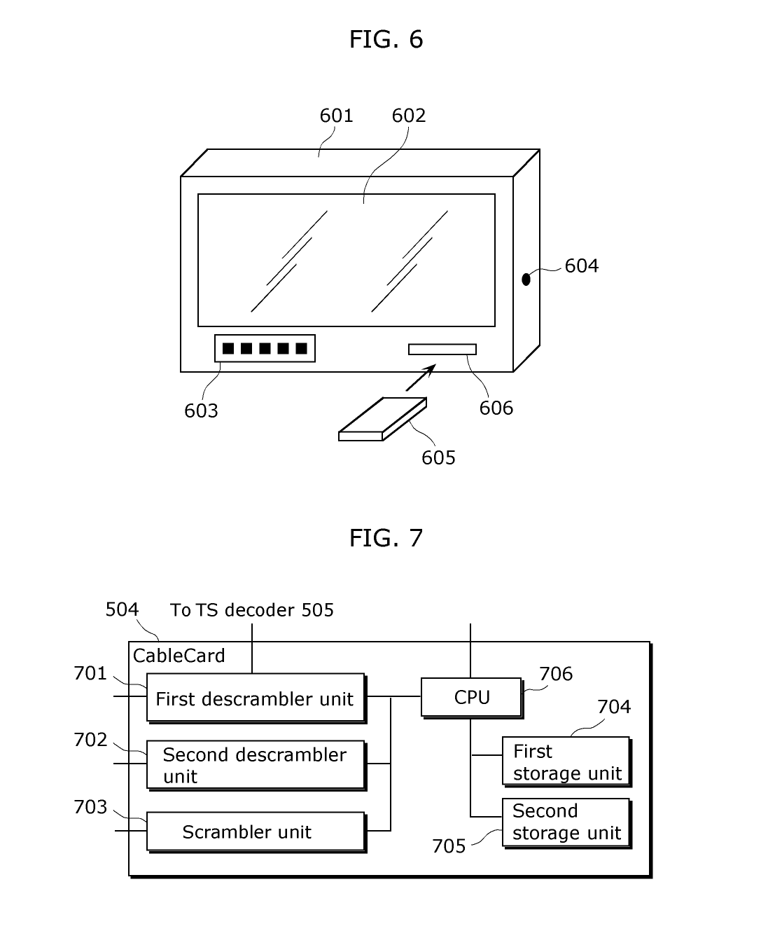

FIG. 6 is a diagram showing a flat-screen television which is an example of the external appearance of the terminal apparatus 500.

A flat-screen television housing 601 houses all constituent elements of the terminal apparatus 500 except the CableCard 504.

A display 602 corresponds to the display 509 in FIG. 5.

A front panel 603 is composed of plural buttons, and corresponds to the input unit 513 in FIG. 5.

A signal input terminal 604 is connected with a cable for performing the sending and receiving of signals with the head end 101. The signal input terminal 604 is connected to the QAM demodulation unit 501, the QPSK demodulation unit 502, and the QPSK modulation unit 503 in FIG. 5.

A CableCard card 605 corresponds to the CableCard 504 in FIG. 5. The CableCard 504 is embodied independently of the terminal apparatus 500 and can be attached to/detached from the terminal apparatus 500, as with the CableCard card 605 in FIG. 6. A detailed description of the CableCard 504 is given later.

An insertion slot 606 is a slot into which the CableCard card 605 is inserted.

Referring to FIG. 5, the QAM demodulation unit 501 demodulates a signal which has been QAM-modulated in and transmitted from the head end 101, according to tuning information that includes a frequency specified by the CPU 514, and passes the result to the CableCard 504.

The QPSK demodulation unit 502 demodulates a signal which has been QPSK-modulated in and transmitted from the head end 101, according to tuning information that includes a frequency specified by the CPU 514, and passes the result to the CableCard 504.

The QPSK modulation unit 503 QPSK-modulates the signal passed from the CableCard 504, according to modulation information that includes a frequency specified by the CPU 514, and transmits the result to the head end 101.

As shown in FIG. 6, the CableCard 504 can be attached to/detached from the terminal apparatus 500. The definition of the connection interface between the terminal apparatus 500 and the CableCard 504 is given in the OpenCable™ CableCard Interface 2.0 Specification (OC-SP-CCIF2.0-I18-090508) and specifications referred to by such specification. Here, a detailed description is omitted, and a description is given only for portions relevant to the present disclosure.

FIG. 7 is a block diagram showing an internal configuration of the CableCard 504. The CableCard 504 includes a first descrambler unit 701, a second descrambler unit 702, a scrambler unit 703, a first storage unit 704, a second storage unit 705, and a CPU (or processor) 706.

The first descrambler unit 701, under instruction from the CPU 706, receives a scrambled signal from the QAM demodulation unit 501 of the terminal apparatus 500, and descrambles such signal. Then, the first descrambler unit 701 transmits the descrambled signal to the TS decoder 505 of the terminal apparatus 500. Information required for decoding such as a key is provided by the CPU 706 as necessary. More specifically, the head end 101 broadcasts several pay channels. When the user purchases the right to view these pay channels, the first descrambler unit 701 receives required information such as a key from the CPU 706 and performs descrambling to thereby allow the user to view these pay channels. When required information such as a key is not provided, the first descrambler unit 701 passes the received signal directly to the TS decoder 505 without performing descrambling.

The second descrambler unit 702, under instruction from the CPU 706, receives a scrambled signal from the QPSK demodulation unit 502 of the terminal apparatus 500, and descrambles such signal. Then, the second descrambler unit 702 passes the descrambled data to the CPU 706.

The scrambler unit 703, under instruction from the CPU 706, scrambles the data received from the CPU 706 and sends the result to the QPSK modulation unit 503 of the terminal apparatus 500.

The first storage unit 704 is specifically configured of a primary memory such as a RAM, and is utilized for storing data temporarily when the CPU 706 performs processing.

The second storage unit 705 is specifically configured of a secondary storage memory such as a flash ROM, and is utilized for storing a program to be executed by the CPU 706 as well as for storing data which should not be deleted even when the power is turned off.

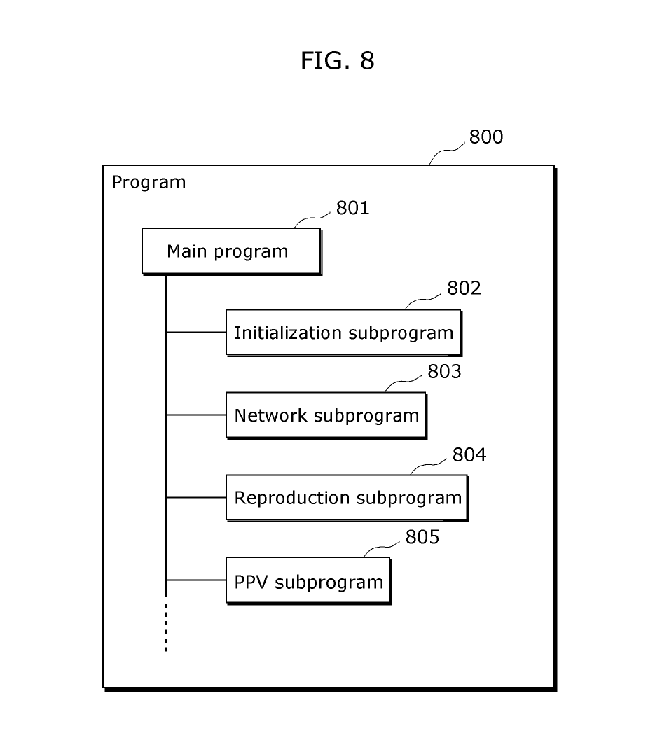

The CPU 706 executes the program stored by the second storage unit 705. The program is made up of plural subprograms. FIG. 8 shows an example of the program stored by the second storage unit 705 In FIG. 8, a program 800 is made up of plural subprograms including a main program 801, an initialization subprogram 802, a network subprogram 803, a reproduction subprogram 804, and a PPV subprogram 805.

Here, PPV is an abbreviation of Pay Per View and refers to a service that enables the viewing of a certain TV program such as a movie, on a charge basis. When the user enters his personal identification number, the purchase of the right to view the program is notified to the head end 101, scrambling is cancelled, and such program can be viewed by the user. With this viewing, the user is required to pay the purchase price at a later date.

The main program 801, which is the subprogram activated first by the CPU 706 when the power is turned on, controls the other subprograms.

The initialization subprogram 802, which is activated by the main program 801 when the power is turned on, performs information exchange with the terminal apparatus 500 and performs initialization. The details of this initialization is defined in detail in the OpenCable™ HOST-CableCard Interface Specification (OC-SP-HOSTCableCard-IF-I12-030210) and in specifications referred to by such specification. Furthermore, the initialization subprogram 802 also performs initialization not defined in these specifications. Here, a part of such initialization is introduced. When the power is turned on, the initialization subprogram 802 notifies the QPSK demodulation unit 502 of a first frequency stored in the second storage unit 705 via the CPU 514 of the terminal apparatus 500. The QPSK demodulation unit 502 performs tuning using the provided first frequency, and transmits the resulting signal to the second descrambler unit 702. Moreover, the initialization subprogram 802 provides the second descrambler unit 702 with descrambling information such as a first key stored in the second storage unit 705. As a result, the second descrambler unit 702 performs descrambling and passes the result to the CPU 706 executing the initialization subprogram 802. As such, the initialization subprogram 802 can receive the information. In this example, the initialization subprogram 802 receives information via the network subprogram 803. A detailed description on this is given later.

Furthermore, the initialization subprogram 802 notifies the QPSK modulation unit 503 of a second frequency stored in the second storage unit 705, via the CPU 514 of the terminal apparatus 500. The initialization subprogram 802 provides the scrambler unit 703 with scrambling information stored in the second storage unit 705. When the initialization subprogram 802 provides, via the network subprogram 803, the scrambler unit 703 with information required to be sent, the scrambler unit 703 scrambles the data using the provided scrambling information, and provides the scrambled data to the QPSK modulation unit 503 of the terminal apparatus 500. The QPSK modulation unit 503 modulates the provided scrambled information, and sends the modulated information to the head end 101.

As a result, it becomes possible for the initialization subprogram 802 to carry out two-way communication with the head end 101, via the terminal apparatus 500, the second descrambler unit 702, the scrambler unit 703, and the network subprogram 803.

The network subprogram 803, which is used by plural subprograms such as the main program 801 and the initialization subprogram 802, is a subprogram intended for carrying out two-way communication with the head end 101. More specifically, the network subprogram 803 behaves as if other subprograms using the network subprogram 803 were carrying out a two-way communication with the head end 101 in accordance with TCP/IP. It should be noted that a detailed description of TCP/IP is omitted here, since it is a publicly known technique which stipulates the protocols for performing the exchange of information between plural terminals. When activated by the initialization subprogram 802 at power-on time, the network subprogram 803 notifies, via the terminal apparatus 500, the head end 101 of an MAC address (an abbreviation of Media Access Control address) which is an identifier for identifying the CableCard 504 and which is stored in the second storage unit 705 beforehand, so as to request for the obtainment of an IP address. The head end 101 notifies the CableCard 504 of the IP address via the terminal apparatus 500, and the network subprogram 803 stores such IP address in the first storage unit 704. From here on, the head end 101 and the CableCard 504 communicate with each other using such IP address as the identifier of the CableCard 504.

The reproduction subprogram 804 provides the first descrambler unit 701 with descrambling information such as a second key stored in the second storage unit 705 as well as descrambling information such as a third key provided by the terminal apparatus 500, so as to allow descrambling to be performed. Furthermore, the reproduction subprogram 804 receives, via the network subprogram 803, information indicating that the signal inputted in the first descrambler unit 701 is a PPV channel. On the notification that the signal is a PPV channel, the reproduction subprogram 804 activates the PPV subprogram 805.

When activated, the PPV subprogram 805 displays, on the terminal apparatus 500, a message prompting the user to purchase the TV show, and accepts an input from the user. More specifically, when information intended to be displayed on the screen is sent to the CPU 514 of the terminal apparatus 500, a program running on the CPU 514 of the terminal apparatus 500 displays the message on the display 509 of the terminal apparatus 500. Then, when the user enters the personal identification number via the input unit 513 of the terminal apparatus 500, the CPU 514 of the terminal apparatus 500 accepts it, and sends it to the PPV subprogram 805 running on the CPU 706 of the CableCard 504. The PPV subprogram 805 sends the accepted personal identification number to the head end 101, via the network subprogram 803. When such personal identification number is valid, the head end 101 notifies, via the network subprogram 803, the PPV subprogram 805 of descrambling information required for descrambling such as a fourth key. The PPV subprogram 805 provides the first descrambler unit 701 with the accepted descrambling information such as the fourth key, and then the first descrambler unit 701 descrambles the signal being inputted using the provided descrambling information.

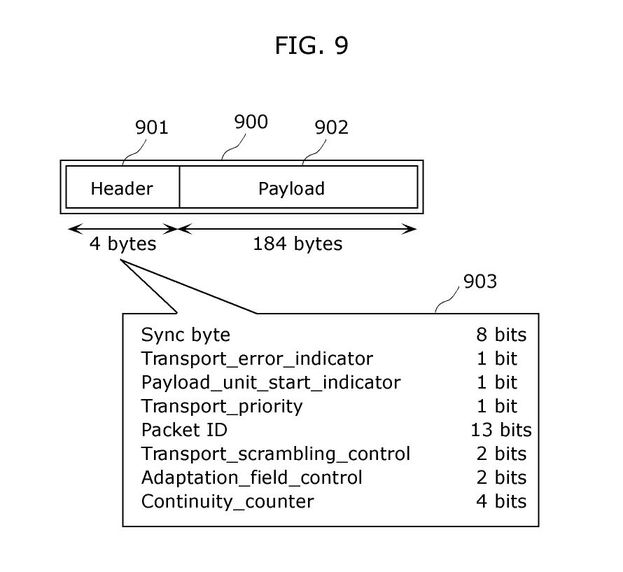

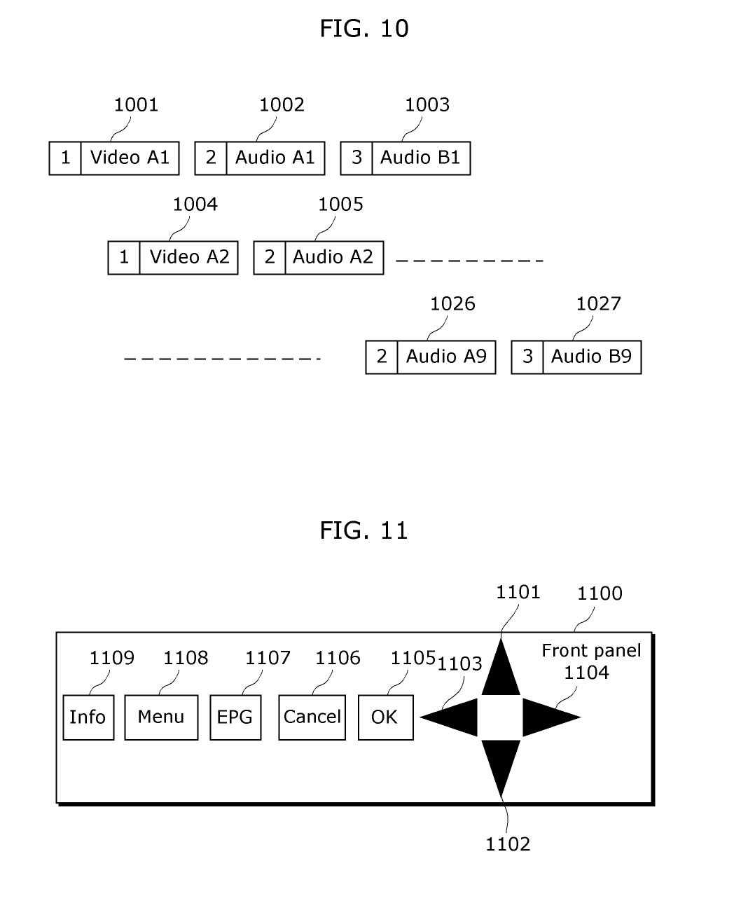

Referring to FIG. 5, the TS decoder 505 performs filtering on the signal accepted from the CableCard 504, and passes necessary data to the audio decoder 506, the video decoder 508, and the CPU 514. Here, the signal sent from the CableCard 504 is an MPEG-2 transport stream. A detailed description about an MPEG-2 transport stream is given in the MPEG specification ISO/IEC13818-1, and therefore detailed description is omitted in this example. An MPEG-2 transport stream is composed of plural fixed-length packets, and a packet ID is assigned to each packet. FIG. 9 is a diagram showing the structure of a packet. A packet 900 is configured of 188 bytes having fixed length. The top four bytes is a header 901 which stores information for identifying the packet. The remaining 184 bytes is a payload 902 which contains the information to be transmitted. 903 shows the breakdown of the header 901. As shown in the breakdown 903, a packet ID is included in the 13 bits of the 12th to 24th bits from the top. FIG. 10 is a schematic diagram illustrating an example of plural packet strings to be transmitted. A packet 1001 carries a packet ID “1” in its header and includes the first information of video A in its payload. A packet 1002 carries a packet ID “2” in its header and includes the first information of audio A in its payload. A packet 1003 carries a packet ID “3” in its header and includes the first information of audio B in its payload.

A packet 1004 carries the packet ID “1” in its header and includes the second information of the video A in its payload, and is the continuation of the packet 1001. Similarly, packets 1005, 1026, and 1027 carry follow-on data of the other packets. By concatenating the contents of the payloads of packets with the same packet IDs in the above manner, it is possible to reproduce a continuing video and audio.

Referring to FIG. 10, when the CPU 514 indicates, to the TS decoder 505, the packet ID “1” as well as “the video decoder 508” as an output destination, the TS decoder 505 extracts packets with the packet ID “1” from the MPEG-2 transport stream received from the CableCard 504, and passes them to the video decoder 508. In the example shown in FIG. 10, only the video data is passed over to the video decoder 508. At the same time, when the CPU 514 indicates, to the TS decoder 505, the packet ID “2” as well as “the audio decoder 506”, the TS decoder 505 extracts packets with the packet ID “2” from the MPEG-2 transport stream received from the CableCard 504, and passes them to the audio decoder 506. In the example shown in FIG. 10, only the audio data is passed over to the audio decoder 506.

This process of extracting only necessary packets according to the packet IDs corresponds to the filtering performed by the TS decoder 505. The TS decoder 505 is capable of performing more than one filtering simultaneously, at the instruction of the CPU 514.

Referring to FIG. 5, the audio decoder 506 concatenates audio data embedded in the packets in the MPEG-2 transport stream provided by the TS decoder 505, performs digital-to-analog conversion on the concatenated data, and outputs the result to the speaker 507.

The speaker 507 outputs the sound of the signal provided by the audio decoder 506, according to the setting specified by the system setting unit 517.

The system setting unit 517 sets the sound volume, the brightness and contrast of the display screen, the display position, and so on, to the speaker 507 and the display 509. Furthermore, in this example, the system setting unit 517 also issues instructions to the display compositing unit 516. Description of the instructions to the display compositing unit 516 is given later.

The video decoder 508 concatenates video data embedded in the packets in the MPEG-2 transport stream provided by the TS decoder 505, and outputs the result to the display 509. Furthermore, the video decoder 508 can also output, to the display compositing unit 516, a still image as shown in MPEG-1, and so on.

It should be noted that, when displaying a still image in MPEG-1 and so on, the displaying may be performed using a still decoder, and the like, other than the video decoder 508.

The OSD control unit 515 performs rendering according to a rendering command for graphics specified by the CPU 514, and outputs the result to the display compositing unit 516.

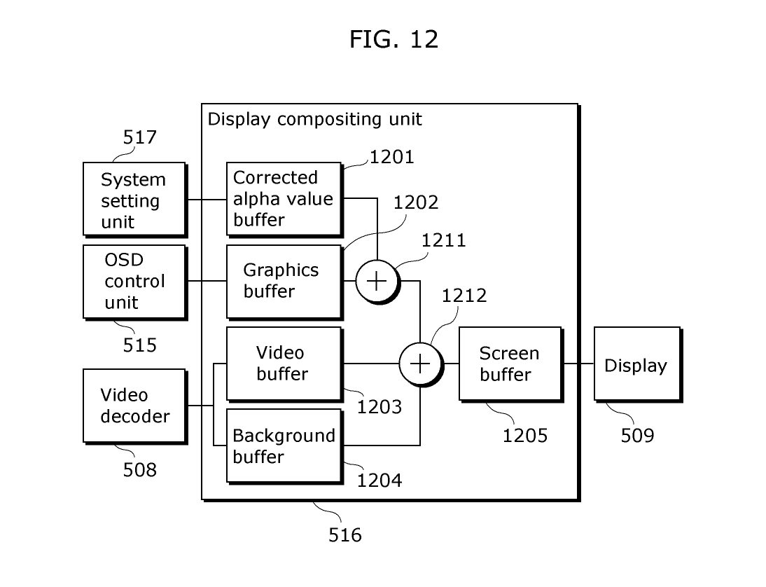

The display compositing unit 516 performs alpha compositing of the video or still image provided by the video decoder 508 and the graphics outputted by the OSD control unit 515, performs digital-to-analog conversion, and outputs the result to the display 509. The display compositing unit 516 has the configuration shown in FIG. 12.

In FIG. 12, description of constituent elements 508, 515, and 517 shall not be repeated as they have already been described earlier. Furthermore, description of the display 509 is given later. A corrected alpha value buffer 1201 stores a value specified by the system setting unit 517, according to an input from the user. An alpha value is a value which represents transparency, and is denoted using a range of 0.0 to 1.0. Here, 0.0 denotes full transparency and 1.0 denotes full opaqueness.

A graphics buffer 1202 stores images, diagrams, and text rendered by the OSD control unit 515. The graphics buffer 1202 stores, for each pixel, the respective values of the three primary colors R (red), G (green), and B (blue), as well as R (alpha value) which represents transparency.

A video buffer 1203 and a background buffer 1204 each store values (foreground color data and background color data) outputted by the video decoder 508.

A compositor 1211 performs an operation of multiplying the corrected alpha value and the R (alpha value) stored in the graphics buffer 1202. When the corrected alpha value is not specified, the compositor 1211 performs the computation assuming that the corrected alpha value is 1.0. It should be noted that the corrected alpha value may be held as any form of value, such as an 8-bit integer value, and so on. Furthermore, a single corrected alpha value or plural corrected alpha values may be prepared for each pixel.

A compositor 1212 performs alpha compositing of (i) the result of the multiplying of the value held by the graphics buffer 1202 and corrected alpha value and (ii) the data inside the video buffer 1203 and the data inside the background buffer 1204. It should be noted that although the corrected alpha value and the alpha values held by the graphics buffer 1202 for the respective pixels are multiplied in this example, the alpha value may be calculated using any method such as not using the values held by the graphics buffer 1202 for the respective pixels and, instead, replacing all of such values with the value of the corrected alpha value. Alpha compositing is processing for compositing a foreground color and a background color at a certain ratio. In this example, computation is performed using the Porter-Duff rule as the computation method. For details of the Porter-Duff rule, see T. Porter and T. Duff, “Compositing Digital Images”, SIGGRAPH 84, 253-259.

A screen buffer 1205 stores the computation result reflected by the compositor 1212, performs digital-to-analog conversion on such result, and outputs the result of the conversion to the display 509 according to the setting specified by the system setting unit 517.

The display 509, which is specifically configured of a Braun tube or a liquid-crystal display, and the like, outputs the output signal provided by the display compositing unit 516 onto a display screen, according to the setting specified by the system setting unit 517.

The secondary storage unit 510, which is specifically configured of a flash memory or a hard disk and the like, stores and deletes data and programs specified by the CPU 514. Furthermore, the stored data and programs are referred to by the CPU 514. The stored data and programs are kept stored even when power to the terminal apparatus 500 is cut off.

The primary storage unit 511, which is specifically configured of a RAM and the like, temporarily stores and deletes data and programs specified by the CPU 514. Furthermore, the stored data and programs are referred to by the CPU 514. The stored data and programs are deleted when power to the terminal apparatus 500 is cut off.

The ROM 512 is a read-only memory device, specifically configured of a ROM, a CD-ROM, or a DVD, and the like. The ROM 512 stores a program to be executed by the CPU 514.

The input unit 513, which is specifically configured of a front panel or remote control, accepts an input from the user. FIG. 11 is a diagram showing an example of the input unit 513 in the case where it is made up of a front panel. A front panel 1100 corresponds to the front panel unit 603 shown in FIG. 6. The front panel 1100 includes nine buttons, namely, an up-cursor button 1101, a down-cursor button 1102, a left-cursor button 1103, a right-cursor button 1104, an OK button 1105, a cancel button 1106, an EPG button 1107, a menu button 1108, and an Info button 1109. When the user presses a button, the identifier of such pressed button is notified to the CPU 514.

The CPU 514 executes the program stored in the ROM 512. Following the instructions from such program to be executed, the CPU 514 controls the QAM demodulation unit 501, the QPSK demodulation unit 502, the QPSK modulation unit 503, the CableCard 504, the TS decoder 505, the display 509, the secondary storage unit 510, the primary storage unit 511, and the ROM 512.

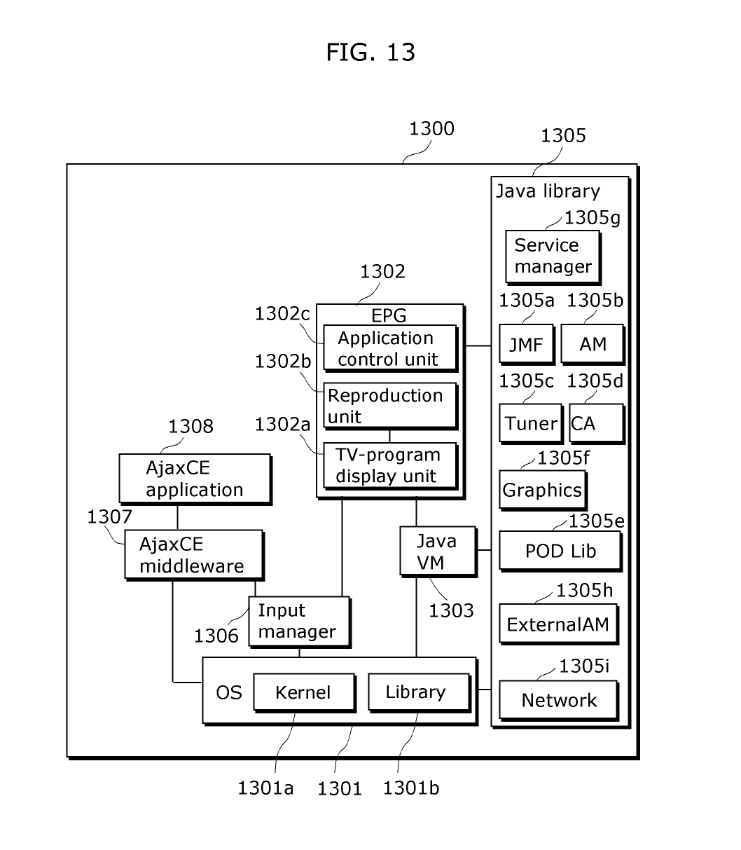

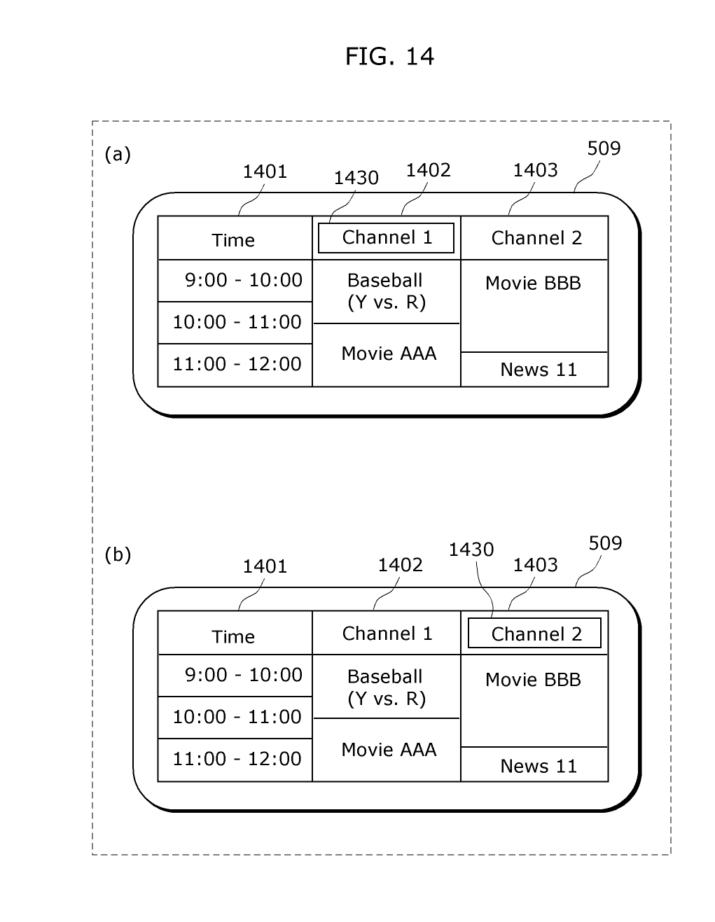

FIG. 13 is a diagram showing an example of the structure of the program stored in the ROM 512 and executed by the CPU 514.

A program 1300 includes plural subprograms, and more specifically includes an operating system (OS) 1301, a Java VM 1303, a Java library 1305, and so on.

The OS 1301 is a subprogram activated by the CPU 514 when power to the terminal apparatus 500 is turned on. The OS 1301 stands for operating system, an example of which is Linux™ and the like. It should be noted that the OS 1301 is a generic name for publicly known technology made up of a kernel 1301a for executing another subprogram concurrently, and of a library 1301b, and therefore detailed description shall be omitted. In this example, the kernel 1301a of the OS 1301 executes, as subprograms, the EPG 1302, the Java VM 1303, an input manager 1306, and AjaxCE middleware 1307 which is a system manager. Furthermore, the library 1301b provides these subprograms with plural functions required for controlling the constituent elements of the terminal apparatus 500.

As an example of such functions, tuning shall be described. In the tuning function, tuning information including a frequency is received from another subprogram and then passed over to the QAM demodulation unit 501. It is possible for the QAM demodulation unit 501 to perform demodulation based on the provided tuning information, and pass the demodulated data to the CableCard 504. As a result, the other subprograms can control the QAM demodulation unit 501 via the library 1301b.

The EPG 1302 is fundamentally a Java program (an application written in Java, in other words, a Java application) created by the Cable service operator. The EPG 1302 includes a TV-program display unit 1302a for displaying a list of TV-programs to the user (Cable service subscriber) as well as for accepting an input from the user via the input manager 1306, and a reproduction unit 1302b for selecting channels. Furthermore, the EPG 1302 includes an application control unit 1302c to be described later. Here, EPG is an abbreviation of Electronic Program Guide.

The input manager 1306 accepts input from the user, and distributes the accepted input to the subprograms requesting for the input from the user, such as the EPG 1302, the AjaxCE middleware 1307, and so on. The AjaxCE middleware 1307 is an example of an application execution engine (middleware) different from the Java VM 1303, and the Java library 1305. An AjaxCE application 1308 runs on the AjaxCE middleware 1307.

The kernel 1301a is activated after power to the terminal apparatus 500 is turned on, and then after the kernel 1301a activates the Java VM 1303 and the Java library 1305 is activated, the EPG 1302 is activated, as a Java application running on the Java VM 1303, by an AM 1305b which is a subprogram included in the Java library 1305. A detailed description on this is given later. Furthermore, description of the Java VM 1303 and the Java library 1305 is given later.

Inside the activated EPG 1302, the TV-program display unit 1302a waits for input from the user via the input unit 513 of the terminal apparatus 500. Here, in the case where the input unit 513 is configured of the front panel 1100 as shown in FIG. 11, when the user presses the EPG button 1107 of the input unit 513, the identifier of the EPG button is notified to the CPU 514. The TV-program display unit 1302a of the EPG 1302, which is a subprogram running on the CPU 514, accepts this identifier and displays TV-program information on the display 509. FIG. 14 (a) and FIG. 14 (b) show examples of a TV-program table displayed on the display 509. Referring to FIG. 14A, TV-program information is displayed on the display 509 in a grid pattern. A column 1401 displays time information. A column 1402 displays a channel name “Channel 1” and TV-programs to be broadcast during time periods corresponding to the respective times described in the column 1401. The TV-program information shows that, on “Channel 1”, a TV-program “Baseball (Y vs. R)” is broadcast from 9:00 to 10:30, and “Movie AAA” is broadcast from 10:30 to 12:00. As in the case of the column 1402, a column 1403 also describes a channel name “Channel 2” and TV shows to be broadcast during time periods corresponding to the respective times described in the column 1401. A TV-program “Movie BBB” is broadcast from 9:00 to 11:00, and “News 11” is broadcast from 11:00 to 12:00. 1430 denotes a cursor. The cursor 1430 moves at the press of the left-cursor 1103 or the right-cursor 1104 on the front panel 1100. When the right-cursor 1104 is pressed in the state illustrated in FIG. 14(a), the cursor 1430 moves towards the right as shown in FIG. 14(b). Furthermore, when the left-cursor 1103 is pressed in the state illustrated in FIG. 14 (b), the cursor 1430 moves towards the left as shown in FIG. 14 (a).

When the OK button 1105 on the front panel 1100 is pressed in the state shown in FIG. 14 (a), the TV-program display unit 1302a notifies the reproduction unit 1302b of the identifier of “Channel 1”. When the OK button 1105 on the front panel 1100 is pressed in the state shown in FIG. 14 (a), the TV-program display unit 1302a notifies the reproduction unit 1302b of the identifier of “Channel 1”.

Furthermore, the TV-program display unit 1302a periodically stores TV-program information to be displayed, from the head end 101 into the primary storage unit 511 via the CableCard 504. Generally, it takes time to obtain TV-program information from the head end 101. However, it becomes possible to quickly display a TV-program table by displaying the TV-program information that is pre-stored in the primary storage unit 511 at the press of the EPG button 1107 of the input unit 513.

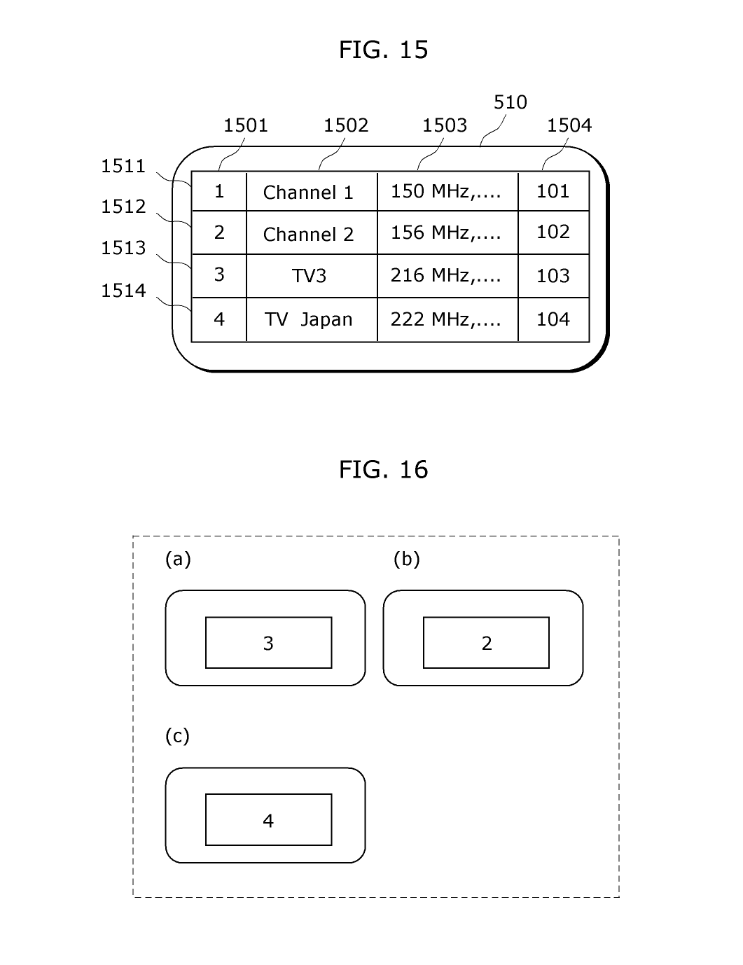

The reproduction unit 1302b reproduces a channel using the received identifier of the channel. The relationship between channel identifiers and channels is pre-stored in the secondary storage unit 510 as channel information. FIG. 15 is a diagram showing an example of channel information stored in the secondary storage unit 510. The channel information is stored in tabular form. A column 1501 describes the identifiers of channels. A column 1502 describes channel names. A column 1503 describes tuning information. Here, the tuning information is represented by values to be provided to the QAM demodulation unit 501 such as frequency, transmission rate, and coding ratio. A column 1504 describes program numbers. Program numbers are numbers used to identify PMTS defined by the MPEG-2 Standard. A description about PMT is given later. Each of rows 1511 to 1514 indicates a set of the identifier, channel name, and tuning information of each channel. The row 1511 describes a set that includes “1” as an identifier, “Channel 1” as a channel name, a frequency of “150 MHz” as tuning information, and “101” as a program number. The reproduction unit 1302b passes the identifier of the received channel directly to the service manager 1305g in order to reproduce the channel.

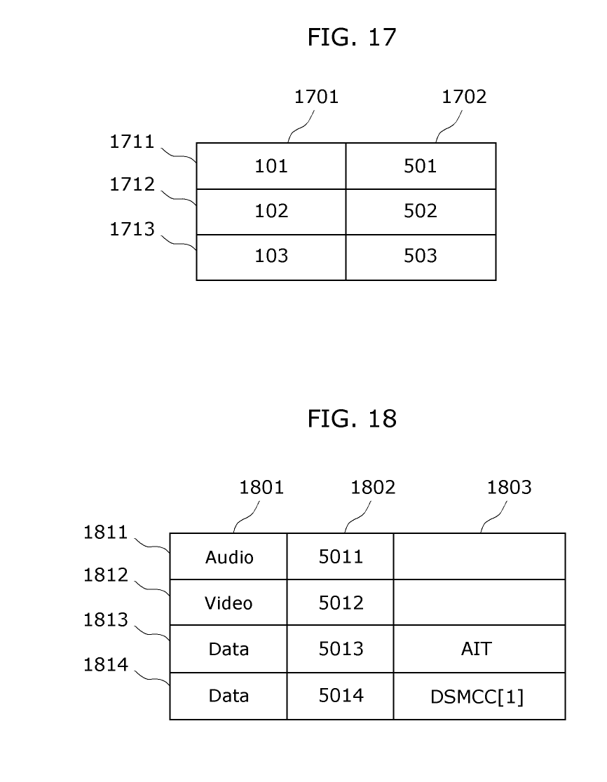

Moreover, when the user presses the up-cursor 1101 and the down-cursor 1102 on the front panel 1100 while reproduction is taking place, the reproduction unit 1302b receives a notification about such pressing from the input unit 513 via the CPU 514, and switches the channel being reproduced to another one. First, the reproduction unit 1302b stores, in the primary storage unit 511, the identifier of the channel that is currently being reproduced. FIGS. 16(a), (b) and (c) show example identifiers of channels stored in the primary storage unit 511. FIG. 16(a) shows that an identifier “3” is stored, and by referring to FIG. 15, it is shown that a channel with the channel name “TV 3” is being reproduced. When the user presses the up-cursor 1101 in the state illustrated in FIG. 16(a), the reproduction unit 1302b refers to the channel information shown in FIG. 15, and passes the identifier “2” of a channel with the channel name of “Channel 2” to the service manager 1305g in order to switch reproduction to the channel with the channel name of “Channel 2” which is the channel preceding that currently being displayed. At the same time, the reproduction unit 1302b rewrites the identifier into the channel identifier “2” stored in the primary storage unit 511. FIG. 16(b) shows the state in which the channel identifier has been rewritten to “2”. Furthermore, when the user presses the down-cursor 1102 in a state illustrated in FIG. 16(a), the reproduction unit 1302b refers to the channel information shown in FIG. 15, and passes the identifier “4” of a channel with the channel name of “TV Japan” to the service manager 1305g in order to switch reproduction to the channel with the channel name of “TV Japan” which is the next channel to that currently being displayed. At the same time, the reproduction unit 1302b rewrites the identifier into the channel identifier “4” stored in the primary storage unit 511. FIG. 16(c) shows the state in which the channel identifier has been rewritten to “4”.

The Java VM 1303 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Furthermore, some Java virtual machines translate the byte code into an execution format which can be interpreted by the CPU 514 before passing it to the CPU 154 which executes it. The Java VM 1303 is activated by the kernel 1301a. Details of the Java language are described in many publications such as in the book (non-patent literature) “Java Language Specification (ISBN 0-201-63451-1)”. Here, detailed description shall be omitted. Furthermore, the detailed operation of the Java VM itself is described in many publications such as the non-patent literature “Java Virtual Machine Specification (ISBN 0-201-63451-X)”. Here, detailed description shall be omitted.

The service manager 1305g, which is a subprogram included in the Java library 1305 and is a Java program written in the Java language, is sequentially executed by the Java VM 1303. It is possible for the service manager 1305g to call or be called by another subprogram not written in the Java language, through the Java Native Interface (JNI). The JNI is also described in many publications such as in the book (non-patent literature) “Java Native Interface” and so on. Here, detailed description shall be omitted. Furthermore, as described later, the service manager 1305g implements AV reproduction using a Tuner 1305c, a CA 1305d, and a JMF 1305a. Furthermore, the service manager 1305g realizes the control of Java applications, using the AM 1305b.

The service manager 1305g first passes the identifier of the channel to the Tuner 1305c in the Java library 1305, and requests for tuning. The Tuner 1305c refers to the channel information stored in the secondary storage unit 510, and obtains the tuning information. Now, when the service manager 1305g passes the identifier “2” of the channel to the Tuner 1305c, the Tuner 1305c refers to the column 1512 shown in FIG. 15, and obtains the corresponding tuning information “156 MHz”. The Tuner 1305c passes the tuning information to the QAM demodulation unit 501, via the library 1301b of the OS 1301. The QAM demodulation unit 501 demodulates the signal sent from the head end 101 according to the given tuning information, and passes the result to the CableCard 504.

Next, the service manager 1305g requests the CA 1305b inside the Java library 1305 to perform descrambling. The CA 1305d provides the CableCard 504 with information required for descrambling, through the library 1301b in the OS 1301. On the basis of such provided information, the CableCard 504 descrambles the signal provided by the QAM demodulation unit 501, and passes the result to the TS decoder 505.

Next, the service manager 1305g provides the identifier of the channel to the JMF 1305a in the Java library 1305, and requests for the reproduction of the video and audio.

First, the JMF 1305a obtains, from a PAT and a PMT, packet IDs used to specify the video and audio to be reproduced. PAT and PMT are tables stipulated by the MPEG-2 Standard that show the TV-program line-up included in an MPEG-2 transport stream. PAT and PMT are embedded in the payloads of packets included in an MPEG-2 transport stream, and sent together with audio and video. Refer to the Specification for details. Here, only the outline shall be described. PAT, which is an abbreviation of Program Association Table, is stored and sent in packets with the packet ID “0”. In order to obtain the PAT, the JMF 1305a indicates, to the TS decoder 505, the packet ID “0” and the CPU 514, through the library 1301b of the OS 1301. The TS decoder 505 performs filtering based on the packet ID “0” and, by passing the result to the CPU 514, the JMF 1305a collects the PAT packets.

FIG. 17 schematically shows an example of the collected PAT information. A column 1701 describes program numbers. A column 1702 describes packet IDs. The packet IDs shown in the column 1702 are used to obtain the PMT. Each of rows 1711 to 1713 is a pair of the program number of a channel and a corresponding packet ID. Here, three channels are defined. The row 1711 defines a pair of the program number “101” and the packet ID “501”. Now, when the channel identifier provided to the JMF 1305a is “2”, the JMF 1305a refers to the column 1512 in FIG. 15 and obtains the corresponding program number “102”, and then refers to the column 1712 in the PAT shown in FIG. 17 and obtains the packet ID “502” corresponding to the program number “102”.

PMT, which is an abbreviation of Program Map Table, is stored and sent in packets of the packet ID stipulated in the PAT. In order to obtain the PMT, the JMF 1305a specifies, to the TS decoder 505, the packet ID and the CPU 514, through the library 1301b of the OS 1301. Here, it is assumed that the packet ID specified is “502”. The TS decoder 505 performs filtering based on the packet ID “502” and, by passing the result to the CPU 514, the JMF 1305a collects the PMT packets.

FIG. 18 schematically shows an example of the collected PMT information. A column 1801 describes stream types. A column 1802 describes packet IDs. Information specified in the respective stream types is stored and sent in the payloads of packets with the packet IDs specified in the column 1802. A column 1803 describes supplementary information. Each of rows 1811 to 1814 is a pair of a packet ID and the type of information being transmitted, which is known as an elementary stream. The row 1811, which is a pair of the stream type “audio” and the packet ID “5011”, indicates that audio data is stored in the payload of the packet with the packet ID “5011”. The JMF 1305a obtains, from the PMT, the packet IDs of the video and audio to be reproduced. Referring to FIG. 18, the JMF 1305a obtains the audio packet ID “5011” from the row 1811, and the video packet ID “5012” from the row 1812.

Next, the JMF 1305a provides the TS decoder 505 with pairs of the obtained audio packet ID and the output destination “audio decoder 506” as well as the video packet ID and the output destination “video decoder 508”, via the library 1301b of the OS 1301. The TS decoder 505 performs filtering based on such provided packet IDs and output destinations. Here, the packet with the packet ID “5011” is passed to the audio decoder 506 and the packet with the packet ID “5012” is passed to the video decoder 508. The audio decoder 506 performs digital-to-analog conversion on the provided packet, and reproduces audio through the speaker 507. The video decoder 508 concatenates video data embedded in the provided packet, and outputs the result to the display compositing unit 516.

Lastly, the service manager 1305g provides the identifier of the channel to the AM 1305b in the Java library 1305, and requests for data broadcast reproduction. Here, data broadcast reproduction refers to extracting a Java program (Java application) included in the MPEG-2 transport stream, and having it executed by the Java VM 1303. As a method of encapsulating a Java program in an MPEG-2 transport stream, a method referred to as DSMCC, which is described in the MPEG Standard ISO/IEC 13818-6, is used. Here, detailed description of DSMCC shall be omitted. The DSMCC defines a method of encoding the file system made up of directories and files used by a computer in the packets of an MPEG-2 transport stream. Furthermore, information about the Java application to be executed is embedded and sent in packets in the MPEG-2 transport stream in a form referred to as AIT. AIT is an abbreviation of Application Information Table defined in the 10th chapter of the DVB-MHP Standard (formally as, ETS TS 101 812 DVB-MHP Specification V1.0.2).

First, in order to obtain the AIT, the AM 1305b obtains the PAT and PMT as in the case of the JMF 1305a, so as to obtain the packet ID of the packet in which the AIT is stored. Now, when “2” is the provided channel identifier and the PAT shown in FIG. 17 and the PMT shown in FIG. 18 are being transmitted, the AM 1305b obtains the PMT shown in FIG. 18 according to the same procedure followed by the JMF 1305a. The AM 1305b extracts, from the PMT, the packet ID of the elementary stream having a stream type of “Data” and which has “AIT” as supplementary information. As shown in FIG. 18, the elementary stream in the row 1813 corresponds to such elementary stream, and therefore the AM 1305b obtains the packet ID “5013” from it.

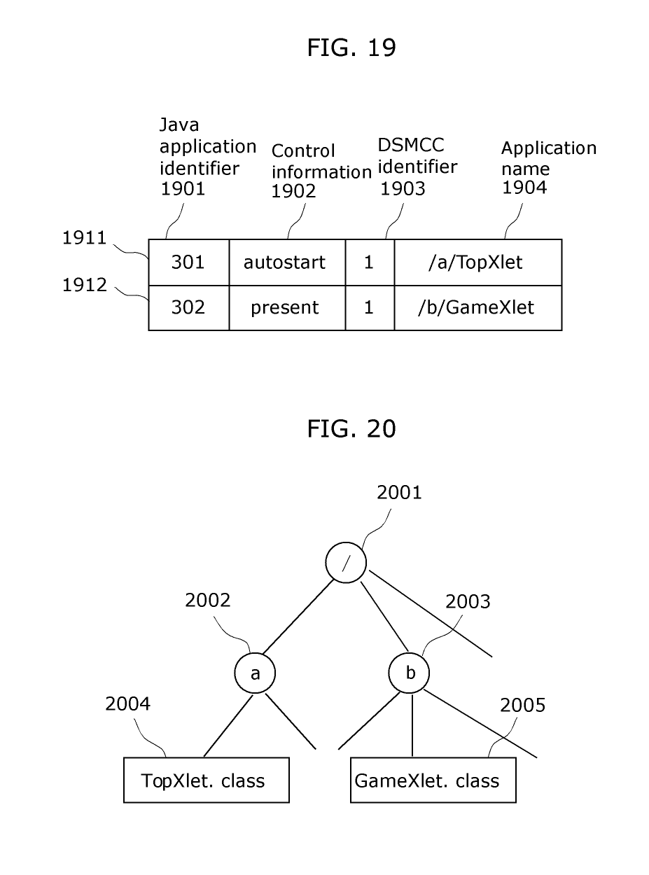

The AM 1305b provides the TS decoder 505 with the packet ID of the AIT and the output destination “CPU 514”, through the library 1301b of the OS 1301. The TS decoder 505 performs filtering based on the provided packet ID, and passes the result to the CPU 514. As a result, the AM 1305b is able to collect the packets of AIT. FIG. 19 schematically shows an example of the collected AIT information. A column 1901 describes the identifiers of Java applications. A column 1902 describes control information of the Java applications. The control information includes “autostart”, “present”, and “kill”. “autostart” means that the terminal apparatus 500 automatically executes the program promptly. “present” means that the program is not executed automatically. “kill” means that the program is to be terminated. A column 1903 describes DSMCC identifiers for extracting packet IDs including a Java application in the

DSMCC format. A column 1904 describes application names of the Java applications. Each of rows 1911 and 1912 is a set of information about a Java application. The Java application defined in the row 1911 is a set of an identifier “301”, control information “autostart”, a DSMCC identifier “1”, and an application name “a/TopXlet”. The Java application defined in the row 1912 is a set of an identifier “302”, control information “present”, a DSMCC identifier “1”, and an application name “b/GameXlet”. Here, the two Java applications have the same DSMCC identifier which indicates that two Java applications are included within a single file system encoded in the DSMCC format. Here, although only 4 items of information are defined for the Java application, more information is actually defined. Refer to the DVB-MHP Standard for details.

The AM 1305b finds the “autostart” Java application from within the AIT, and extracts the corresponding DSMCC identifier and Java application name. Referring to FIG. 19, the AM 1305b extracts the Java application in the row 1911, and obtains the DSMCC identifier “1” and the Java application name “a/TopXlet”.

Next, using the DSMCC identifier obtained from the AIT, the AM 1305b obtains, from the PMT, the packet ID of packets that store Java applications in the DSMCC format. More specifically, the AM 1305b obtains, from within the PMT, the packet ID of the elementary stream having a stream type “Data” and a matching DSMCC identifier in the supplementary information.

Now, assuming that such DSMCC identifier is “1” and the PMT is the example shown in FIG. 18, the elementary stream in the row 1814 matches, and the packet ID “5014” is to be extracted.

The AM 1305b specifies the packet ID of packets in which data is embedded in the DSMCC format as well as the output destination “CPU 514”, to the TS decoder 505 through the library 1301b of the OS 1301. Here, the packet ID “5014” is provided. The TS decoder 505 performs filtering based on the provided packet ID, and passes the result to the CPU 514. As a result, the AM 1305b is able to collect the required packets. The AM 1305b reconstructs the file system from the collected packets, according to the DSMCC format, and stores this in the primary storage unit 511. It should be noted that importing data or a program from the outside, specifically, extracting data such as the file system from packets in the MPEG-2 transport stream and storing the extracted data into storage units such as the primary storage unit 511 is hereinafter called “download”.

FIG. 20 is a diagram showing an example of a downloaded file system. In the figure, a circle denotes a directory and a square denotes a file. 2001 denotes a root directory, 2002 denotes a directory “a”, 2003 denotes a directory “b”, 2004 denotes a file “TopXlet.class”, and 2005 denotes a file “GameXlet.class”.

Subsequently, the AM 1305b passes, to the Java VM 1303, a Java application to be executed out of the file system downloaded into the primary storage unit 511. Now, assuming that the Java application name to be executed is “a/TopXlet”, a file “a/TopXlet.class”, resulting from the appendage of “.class” to the end of the above Java application name, is the file to be executed. “/” is a division of a directory and file name. Here, as shown in FIG. 20, the file 2004 is a Java application to be executed. Next, the AM 1305b passes the file 2004 to the VM 1303.

The Java application executed by the AM 1305b can be displayed on the display screen by executing a rendering command of an image or text using a Graphics 1305f.

The Graphics 1305f implements the rendering of an image or text for a rendering command received from the Java application, by issuing a rendering instruction to the OSD control unit 515 through the CPU 514.

A Network 1305i realizes communication with an arbitrary server specified by the Java application, using the previously described CableCard 504, QPSK demodulation unit 502, and QPSK modulation unit 503.

The Java VM 1303 executes the received Java application.

Upon receiving an other channel identifier, the service manager 1305g stops, through the respective libraries included in the Java library 1305, the execution of the video and audio currently being reproduced and Java program currently being executed likewise through the respective libraries included in the Java library 405, and performs the reproduction of video and audio and execution of a Java program based on the newly received channel identifier.

The Java library 1305 is a collection of plural Java libraries stored in the ROM 512. In this example, the Java library 1305 includes the service manager 1305, the JMF 1305a, the AM 1305b, the Tuner 1305c, the CA 1305d, a CableCard Lib (POD Lib) 1305e, the Graphics 1305f, and so on.

Here, description regarding the activation of the EPG 1302 is given. In this example, the EPG 1302 is described as a Java application.

The kernel 1301a is activated after power to the terminal apparatus 500 is turned on, and the kernel 1301a activates the Java VM 1303, and the Java library 1305 is initialized. At the time of the initialization of the Java library 1305, the AM 1305b, which is a subprogram, carries out two-way communication with the head end 101, via the CableCard Lib 1305e included in the Java library 1305. This two-way communication is implemented using the QPSK demodulation unit 502 and the QPSK modulation unit 503, via the CableCard Lib 1305e, the library 1301b of the OS 1301, and the CableCard 504.

Using this communication, the AM 1305b receives the information on the Java application that should be stored into the secondary storage unit 510 by the terminal apparatus 500. This information shall be called XAIT information. XAIT information is transmitted in an arbitrary format between the head end 101 and the CableCard 504.

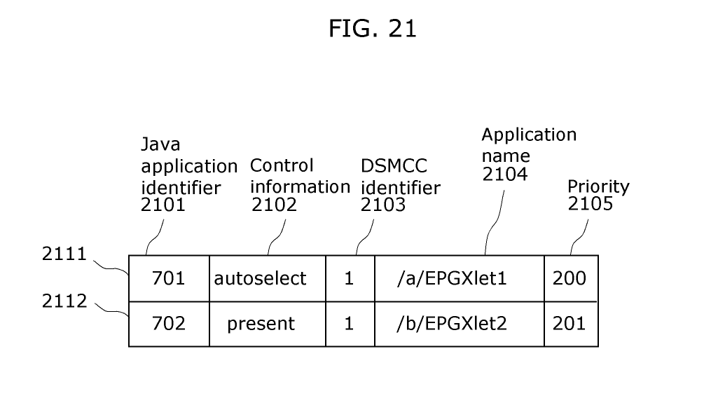

FIG. 21 is a table schematically showing an example of the information of the XAIT obtained from the head end 101. A column 2101 describes the identifiers of Java applications. A column 2102 describes control information of the Java applications. Control information includes “autoselect”, “present”, and so on. “autoselect” means that the terminal apparatus 500 automatically executes the program when the power is turned on. “present” means that the program is not executed automatically. A column 2103 describes DSMCC identifiers for extracting packet IDs including a Java application in the DSMCC format. A column 2104 describes application names of the Java applications. A column 2105 describes the priority of the Java applications. Each of rows 2111 and 2112 is a set of information about a Java application. The Java application defined in the row 2111 is a set of an identifier “701”, control information “autoselect”, a DSMCC identifier “1”, and an application name “a/EPGXlet1”.

Upon receiving the XAIT information, the AM 1305b stores the file system from the MPEG-2 transport stream, into the primary storage unit 511, according to the same procedure followed when a Java application is downloaded from AIT information. Subsequently, the AM 1305b copies the stored file system, in the secondary storage unit 510. It should be noted that it is also possible to download directly to the secondary storage unit 510 without passing through the primary storage unit 511.

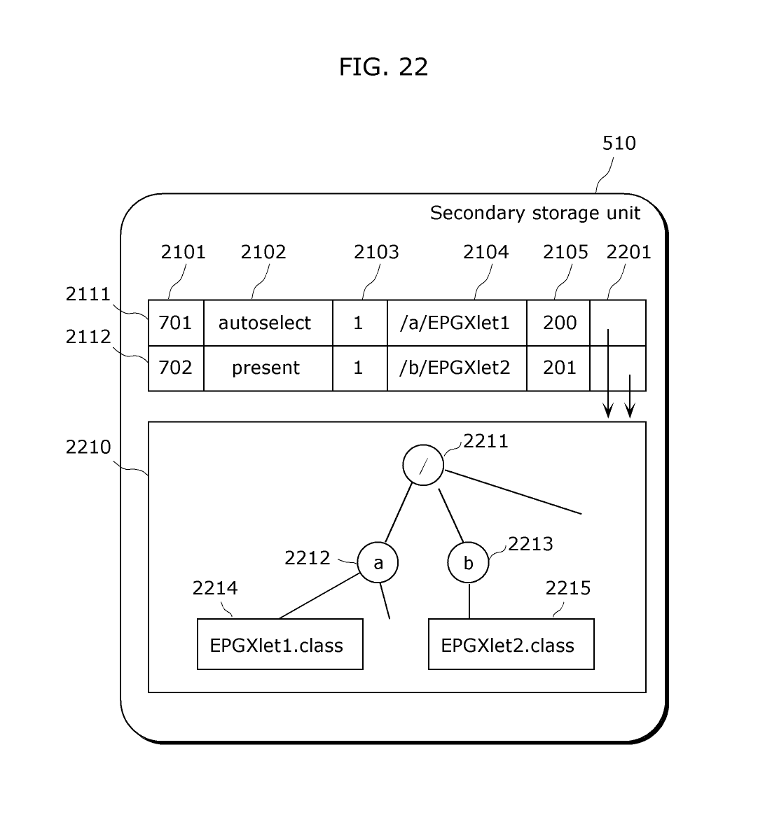

Next, the AM 1305b stores the storage location of the downloaded file system in the secondary storage unit 510, in association with the XAIT information. FIG. 22 shows an example of the secondary storage unit 510 storing the XAIT information and the downloaded file system in association with each other. It should be noted that, in FIG. 22, elements having the same reference signs as in FIG. 21 are the same as those in FIG. 21, and thus description thereof shall not be repeated. A column 2201 stores the storage locations of corresponding downloaded file systems. In the figure, the storage locations are indicated by arrows. 2210 is a downloaded file system which holds therein a top directory 2211, a directory “a” 2212, a directory “b” 2213, a file “EXPGXlet1.class” 2214, and a file “EPGXlet2.class” 2215.

Here, although the XAIT information is stored after the Java application is stored, it may be stored before storing the Java application.

After power to the terminal apparatus 500 is turned on, the OS 1301 specifies the Java VM 1303 to the service manager 1305g, and after the when the Java VM 1303 activates the service manager 1305g, the service manager 1305g first refers to the XAIT information stored in the secondary storage unit 510. Here, the service manager 1305g refers to the control information of the respective Java applications and passes, to the Java VM 1303, the “autoselect” program. Referring to FIG. 22, the Java application “EPGXlet1” defined in the row 2111 is activated. Here, since the Java application described in the AIT is tuning-dependent, there are instances where the activated Java application stops when the user selects an other channel. However, unlike the Java application described in the AIT, the Java application described in the information of XAIT does not stop unless intentionally stopped, because it is not tuning-dependent.

It should be noted that a Java application that is not automatically executed according to “autoselect” can also be activated by the EPG 1302 itself.

### Application Example 1

Next, the operation of an application which performs billing management shall be described as application example 1.

Here, the control of an external application, which is the object of the present disclosure, shall be described using the application control unit 1302c which is defined as a subprogram of the EPG 1302. The application control unit 1302c is a subprogram that controls an external application that does not run on either the Java VM 1303 or the Java library 1305. It should be noted that in this application example, the AjaxCE application 1308 shall be used as an example of the external application. An AjaxCE application 1308 runs on the AjaxCE middleware 1307.

Specifically, in this application example, the AjaxCE middleware 1307 is an example of first middleware that runs on the OS 1301, the Java VM 1303 and the Java library 1305 are examples of second middleware that run on the OS 1301, the AjaxCE application 1308 is an example of a first application program that runs on the first middleware, and the EPG 1302 (or the application control unit 1302c) is an example of a second application program that runs on the second middleware and performs billing or parental lock management (in this application example, billing).

It should be noted that, although the AjaxCE application 1308 and the AjaxCE middleware 1307 are used in this example, the external application (first application) and the middleware (first middleware) serving as the execution engine thereof are not limited to these, and the present disclosure may be applied to arbitrary applications and middleware running on a set top box.

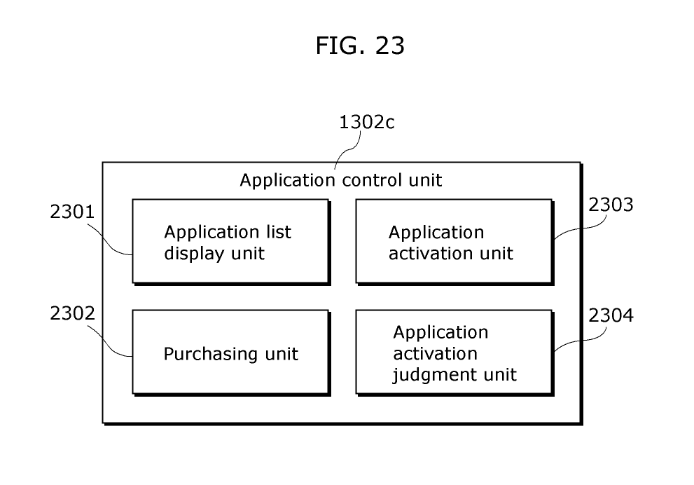

Furthermore, application control unit 1302c is configured as shown in FIG. 23. Specifically, the application control unit 1302c includes an application list display unit 2301, a purchasing unit 2302, an application activation unit 2303, and an application activation judgment unit 2304.

The application list display unit 2301 is a processing unit that displays at least an application program running on the first middleware (here, the AjaxCE middleware 1307) and accepts an instruction to execute the first application program (here, the AjaxCE application 1308). Here, the application list display unit 2301 displays application programs running on the first middleware (here, the AjaxCE middleware 1307) and the second middleware (here, the Java VM 1303), and accepts instructions for the execution of these application programs.

The application activation judgment unit 2304 is a processing unit that obtains billing information regarding whether or not the first application program (here, the AjaxCE application 1308) has been purchased, and judges, based on the obtained billing information, whether or not the first application program (here, the AjaxCE application 1308) is executable. It should be noted that the billing information is information pertaining to whether or not the first application program (here, the AjaxCE application 1308) has been purchased, and does not necessarily have to include information regarding charges.

It should be noted that the application list display unit 2301 and the application activation judgment unit 2304 respectively perform the aforementioned list display and activation judgment by referring to a database (an ExternalAppsDatabase defined by an External AM 1305h) which holds in advance the attributes of application programs, including the first application program and the second application program, which run on the first middleware and second middleware.

The application activation unit 2303 is a processing unit which, in the case where the application activation judgment unit 2304 judges that the first application program (here, the AjaxCE application 1308) is executable, activates the first application program, through the second middleware (here, the Java VM 1303 and the Java library 1305) and the first middleware (here, the AjaxCE middleware 1307).

The purchasing unit 2302 is a processing unit which, in the case where the application activation judgment unit 2304 judges that the first application program (here, the AjaxCE application 1308) is not executable because it has not yet been purchased, performs purchase-processing of the first application program (here, the AjaxCE application 1308).

Hereinafter, more detailed description of these constituent elements is given.

When a certain button, for example, the Info button 1109 is pressed during the display of the EPG screen as in FIG. 14, the application list display unit 2301, which is a subprogram of the application control unit 1302c, displays a list of applications on the display screen.

The application list display unit 2301, obtains the list of applications using the External AM 1305h of the Java library 1305.

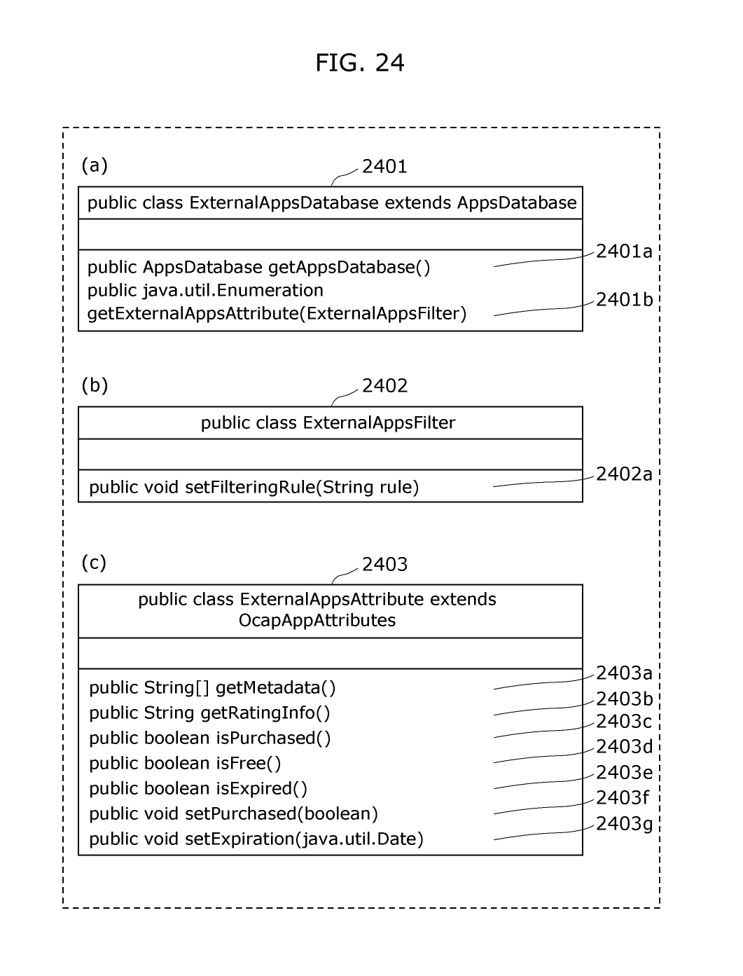

Here, as shown in FIG. 24, classes (ExternalAppsDatabase class 2401, ExternalAppFilter class 2402, ExternalAppsAttribute class 2403) are defined in the External AM 1305h. As shown in FIG. 24(a), the ExternalAppsDatabase class 2401 is an extension of the AppsDatabase class defined in the DVB-MHP Standard. This class manages information of individual applications (Java programs). A getAppsDatabase method 2401a of the ExternalAppsDatabase class 2401 is used for obtaining the instance of the ExternalAppsDatabase class 2401. A getExternalAppsAttibute(ExternalAppFilter) method 2401b of the ExternalAppsDatabase class 2401 returns a list of instances of the ExternalAppsAttribute class 2403 that are compliant with the criteria designated by the argument ExternalAppFilter.

As shown in FIG. 24(c), the ExternalAppsAttribute class 2403 is an extension of the OcapAppAttributes class defined in the OCAP Standard. This class holds information regarding individual applications. For example, the identifiers (ID) of the applications, the types (differentiation for an OCAP application or otherwise, etc.) of the applications, priority, and so on, are defined. A getMetadata( ) method 2403a of the ExternalAppsAttribute class 2403 returns detailed information required for describing what kind of application an external application is. The getMetaData( )method 2403a returns an array of character strings as a return value. A single character string represents the pair of a key and its value, and is configured in a “key=value” form. When plural values exist for a single key, the character string is configured like “key=value 1, value 2”. As an example, character strings are configured as “genre=action”, “author=aaa”. Aside from this, description regarding the key and value used in the present disclosure shall be given as necessary.

A getRatingInfo( )method 2403b of the ExternalAppsAttribute class 2403 returns rating information of the application indicated by the instance of the ExternalAppsAttribute class 2403. For example, the getRatingInfo( )method 2403b returns rating information as a character string such as “E10+” and so on. It should be noted that “E10+” means the intended viewer age is 10 years old and above.

An isPurchased( )method 2403c of the ExternalAppsAttribute class 2403 indicates whether or not the application is already purchased. Basically, it is expected that a purchased application is stored in the set top box. However, depending on the case, it is also possible that, instead of being stored, the application is downloaded at every execution.

An isFree( )method 2403d of the ExternalAppsAttribute class 2403 indicates whether or not the application is free of charge.

An isExpired( )method 2403e of the ExternalAppsAttribute class 2403 indicates whether or not the application is within its expiration term.

The setPurchased(boolean) method 2403f of the ExternalAppsAttribute class 2403 sets whether or not the application is purchased.

The setExpiration(java.util.Date) method 2403g of the ExternalAppsAttribute class 2403 is used in setting the expiration term of the application.

As shown in FIG. 24(b), the ExternalAppFilter class 2402 is used in filtering for the application to be obtained, using the arguments of getExternalAppsAttibute method 2401b of the ExternalAppsDatabase class 2401. The filtering rule is defined using the setFilterRule(String) method 2402a of the ExternalAppFilter class 2402. For example, when “genre=action, puzzle” is assumed as the filtering rule, an application having metadata that complies with such rule is obtained.

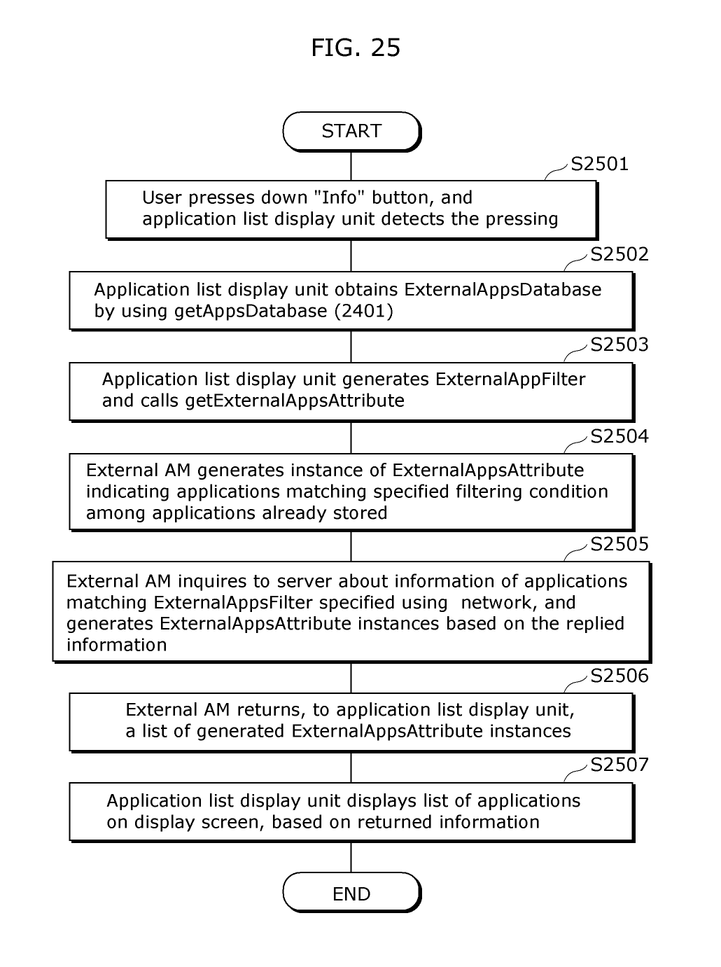

The sequence when the application list display unit 2301 displays a list of applications is shown in FIG. 25.

First, when the user presses the Info button 1109, the application list display unit 2301 detects such pressing (S2501). The application list display unit 2301 obtains the ExternalAppsData base by using the getAppsDatabase method 2401a (S2502). The application list display unit 2301 generates an ExternalAppFilter and calls the getExternalAppsAttribute method 2401b (S2503). The External AM 1305h generates the instance (ExternalAppsAttribute instance) of the ExternalAppsAttribute class 2403 indicating applications that match the specified filtering condition among the applications already stored (S2504). The External AM 1305h inquires to the server about information of applications that match the ExternalAppsFilter specified using a network 1305i, and generates ExternalAppsAttribute instances based on the replied information (S2505). The External AM 1305h returns, to the application list display unit 2301, a list of the generated ExternalAppsAttribute instances (S2506). Lastly, the application list display unit 2301 displays a list of applications on the display screen, based on the returned information (S2507).

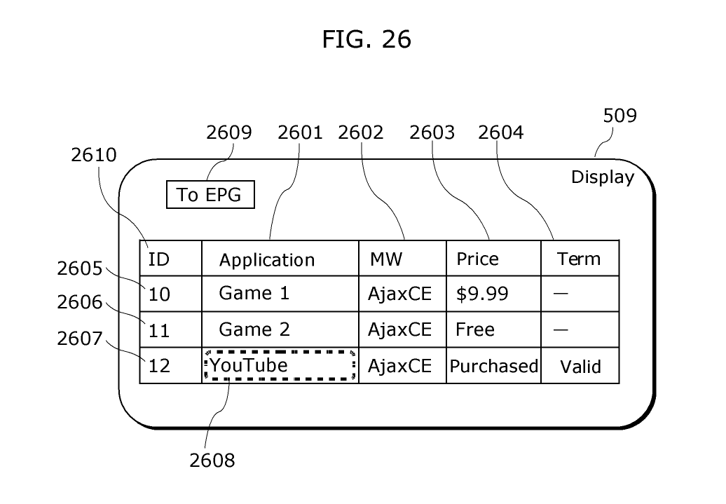

An application list screen according to the application list display unit 2301 is shown in FIG. 26. In FIG. 26, a column 2601 describes application names, a column 2602 describes the middleware on which the applications run, a column 2603 describes whether or not the applications are purchased or the prices of the applications (that is, billing information). The value obtained by the isPurchased( )method 2403f is referred to regarding whether or not the application is purchased. With regard to the price, among the values obtained by the getMetadata( )method 2403a, the value after “price=” is referred to. A column 2604 shows the expiration term when the application is purchased. This references the return value of the isExpired( ) method 2403e. Furthermore, a column 2610 describes the identifiers of the respective applications. A row 2605 describes a first application. The row 2605 shows that the application has an application ID (identifier) 10, runs on AjaxCE middleware, is not yet purchased, and is priced at $9.99. A row 2606 describes a second application, and specifically shows that the application has an identifier 11, runs on AjaxCE middleware, and is free. A row 2607 describes a third application, and specifically shows that such application has an identifier 12, runs on AjaxCE middleware, and is already purchased. Furthermore, the row 2607 also shows that the application is within the expiration term (valid). 2608 represents the cursor, and such cursor moves up and down at the press of the up-cursor 1101 and the down-cursor 1102, respectively. A button 2609 indicates that, when the OK button 1105 is pressed when the cursor is on the button 2609, the screen returns to the EPG screen shown in FIG. 14.

It should be noted that only AjaxCE is listed as middleware in this example because, by performing filtering using the ExternalAppsFilter in step S2503 in FIG. 25 so as to obtain only applications running on AjaxCE middleware, it is possible to obtain only applications running on AjaxCE middleware, and thus the applications from row 2605 to row 2607 in FIG. 26 can be listed using the obtained information. Thus, the filtering conditions for filtering using the ExternalAppsFilter can be set using a setting for which the user has set preferences in advance.

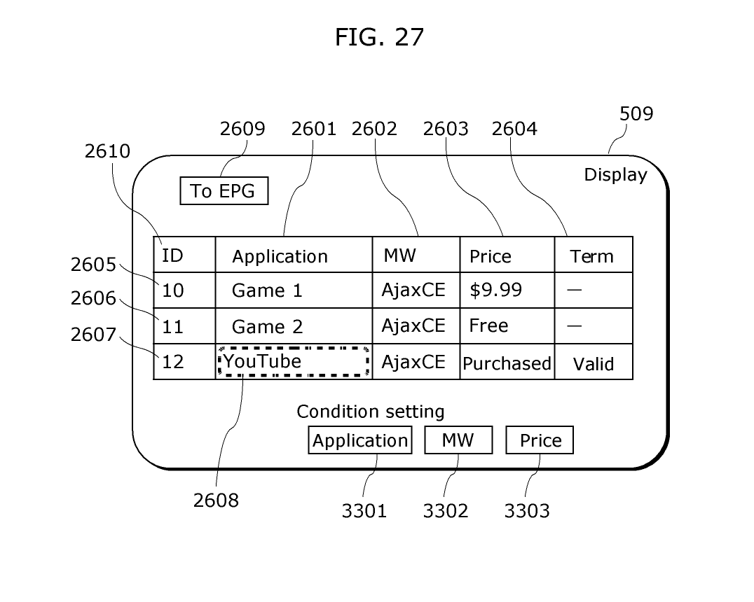

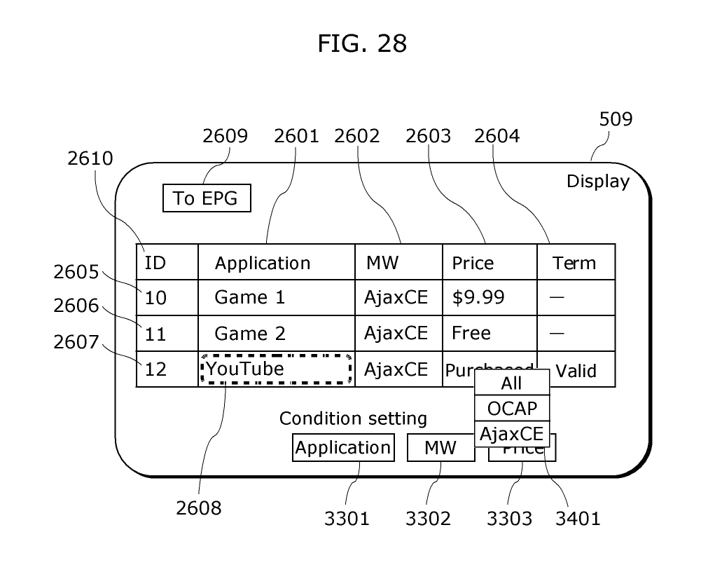

It should be noted that, for the filtering of the application list, a button which allows the setting of the filtering condition may be provided, as shown in the display example shown in FIG. 27. In FIG. 27, 3301 denotes a button which enables the setting of the filtering for the type of application such as game, popular application, and new application. 3302 denotes a button which enables the setting of the filtering for the type of middleware. 3303 denotes a button that enables the setting of the filtering of the type of price such as, with-charge, free, and so on. Refer to FIG. 26 for the other details as they are the same as in FIG. 26. Here, an example of the display when the button 3302 is pressed is shown in FIG. 28. When the cursor is placed on 3302 and the button is pressed, buttons through which the type of middleware can be selected are displayed, as in the list 3401 in FIG. 28. The list 3401 lists up the three buttons, namely, “All”, “OCAP”, and “AjaxCE”. Here, when “AjaxCE” is selected, applications running on AjaxCE middleware are shown as in rows 2605 to 2607 in FIG. 27.

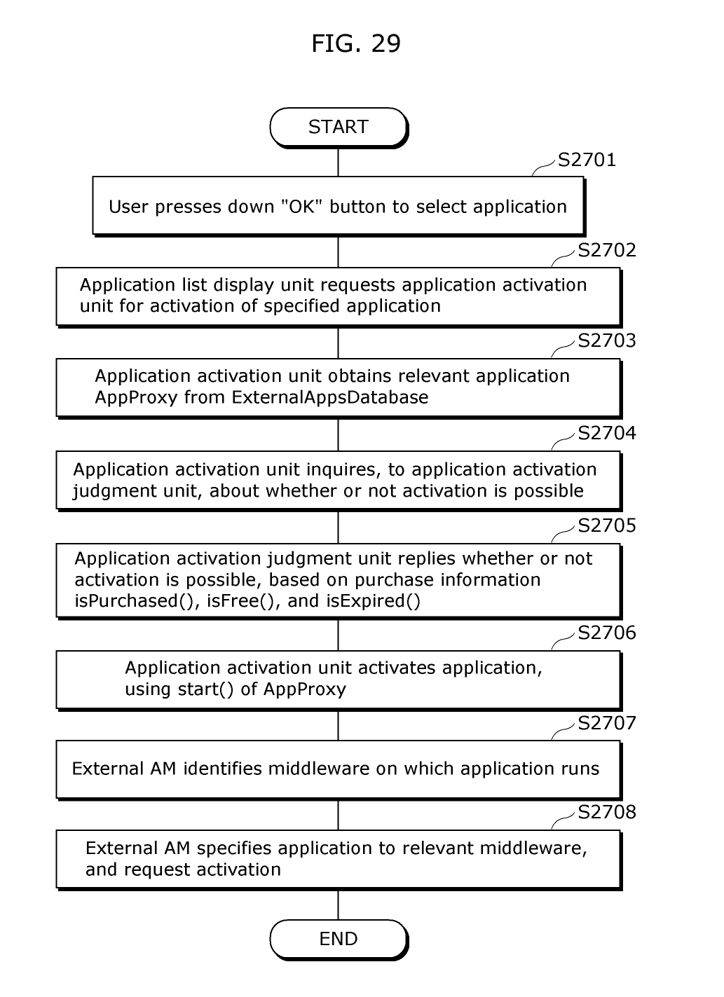

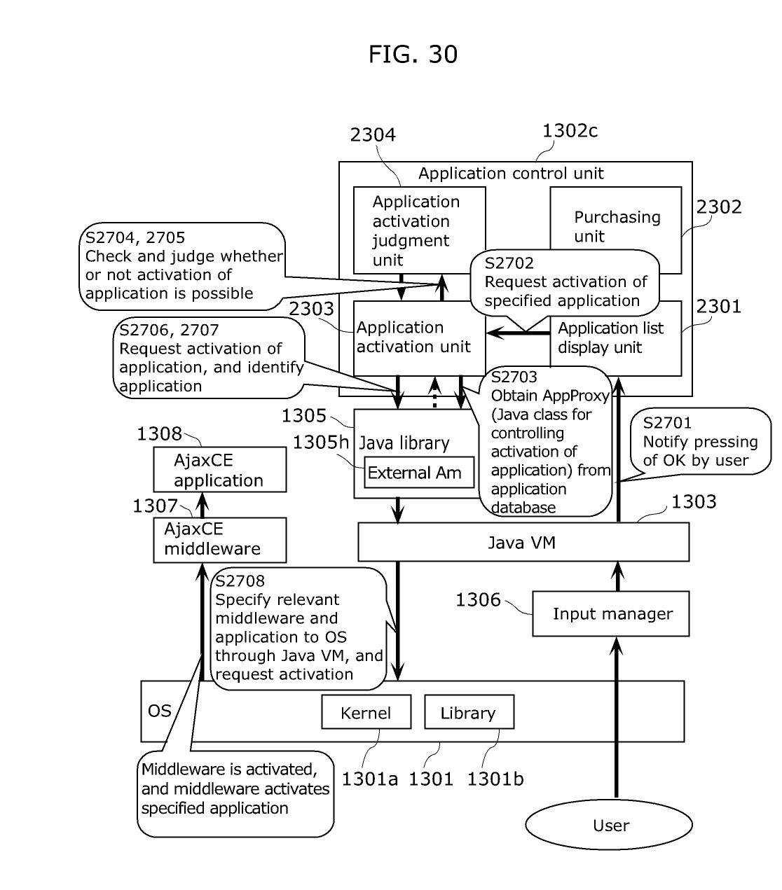

Here, with reference to FIG. 26, the sequence when the cursor is placed such that the purchased application “YouTube” (row 2607 in FIG. 26) is selected is shown in FIG. 29. FIG. 29 is a flowchart showing the sequence for activating the external application according to the present disclosure. FIG. 30 is a diagram for describing the activation sequence in FIG. 29. The program configuration stored by the terminal apparatus 500 and the steps in FIG. 29 are described in FIG. 30. Hereinafter, description is given with reference to FIG. 29 and FIG. 30.

First, the user presses the OK button 1105 so as to select the application “YouTube” (row 2607 in FIG. 26) (S2701). Specifically, the application list display unit 2301 receives an instruction to execute the first application program (here, the application “YouTube”) (receiving step).

The application list display unit 2301 passes, to the application activation unit 2303, the identifier of the specified application “YouTube” (row 2607 in FIG. 26), and requests activation (S2702).

The application activation unit 2303 obtains the relevant application AppProxy from the ExternalAppsDatabase (S2703). Here, AppProxy is a class defined by the DVB-MHP Standard, and lifecycle control, such as the starting and stopping of an application, can be performed using this class.

Next, the application activation unit 2303 passes, to the application activation judgment unit 2304, the identifier of the specified application “YouTube” (row 2607 in FIG. 26), and inquires about whether or not activation is possible (S2704).

The application activation judgment unit 2304 replies whether or not activation is possible, based on the purchase information isPurchased( )method 2403c, isFree( )method 2403d, and isExpired( ) method 2403e of the application “YouTube” (S2705). Specifically, the application activation judgment unit 2304 obtains billing information regarding whether or not the first application program (here, the application “YouTube”) has been purchased (obtaining step), and judges, based on the obtained billing information, whether or not the first application program (here, the application “YouTube”) can be executed (judging step). Here, since the application “YouTube” is already purchased (see FIG. 27), the application activation judgment unit 2304 returns a reply of activation possible to the application activation unit 2303.

The application activation unit 2303 requests for the activation of the application to the External AM 1305h, using the start( )method of the AppProxy class (S2706). Specifically, when the application activation judgment unit 2304 judges that the first application program (here, the application “YouTube”) is executable, the application activation unit 2303 activates the first application program, through the second middleware (here, the Java VM 1303 and the Java library 1305) and the first middleware (here, the AjaxCE middleware 1307) (activating step). Specifically, the following processing is performed.

The External AM 1305h identifies the middleware on which the application runs (S2707). For example, the identification is possible by referring to the portion after the character string “middleware=” among the return values of the getMetadata( )2403a of the ExternalAppsAttribute class 2403.

Lastly, the External AM 1305h passes the identifier of the application “YouTube” to the relevant middleware, in this case, the AjaxCE middleware 1307, and requests activation (S2708).

As described above, according to application example 1, in the terminal apparatus 500 including the first application (AjaxCE application 1308) running on the first middleware (AjaxCE middleware 1307) and the second application (application control unit 1302c) which runs on the second middleware (Java VM 1303) and performs management of billing or parental locking, the second application receives an instruction to execute the first application (S2071), obtains billing information of the first application and judges whether or not the first application can be executed (S2702 to S2705), and activates the first application through the second middleware and the first middleware when it judges that execution is possible (S2706 to S2708).

With this, the judging of executability and the activation with respect to a first application program running on the first middleware is performed under the management of a second application program running on the second middleware. Therefore, management regarding billing for application programs running on respective different middleware is unified under the management of the second application program. As a result, the user can manage the billing for plural application programs running on different middleware through a single unified operation (for example, operation on an OCAP application).

It should be noted that the application to be activated may be stored in the secondary storage unit 510 of the set top box, or may be downloaded directly from a server that stores the application “YouTube”. In the case of activating by downloading from a server, the AjaxCE middleware 1307 activates the application “YouTube” (specifically, the AjaxCE application 1308) by downloading the application to the primary storage unit 511 and reading the application from the primary storage 511. However, the purchase status of the application needs to be stored.

It should be noted that, since the sequence in the case of the free application “game 2” (row 2606 in FIG. 26) is the same as that described above, description shall be omitted.

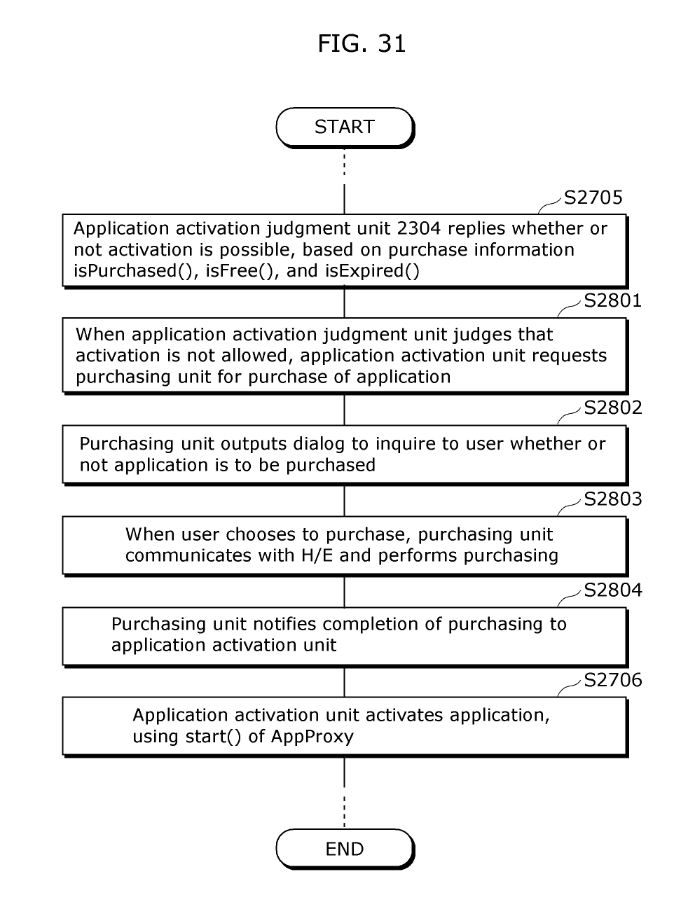

Next, the sequence for activating the not-purchased application “game 1” (row 2605 in FIG. 26) is shown in FIG. 31. It should be noted that, up to step S2705, the sequence is the same as the sequence for the purchased application “YouTube” (row 2607 in FIG. 26).

When the application activation judgment unit 2304 judges that activation is not allowed, and the cause of which is that the application is not yet purchased, the application activation unit 2303 requests purchasing to the purchasing unit 2302 (S2801).

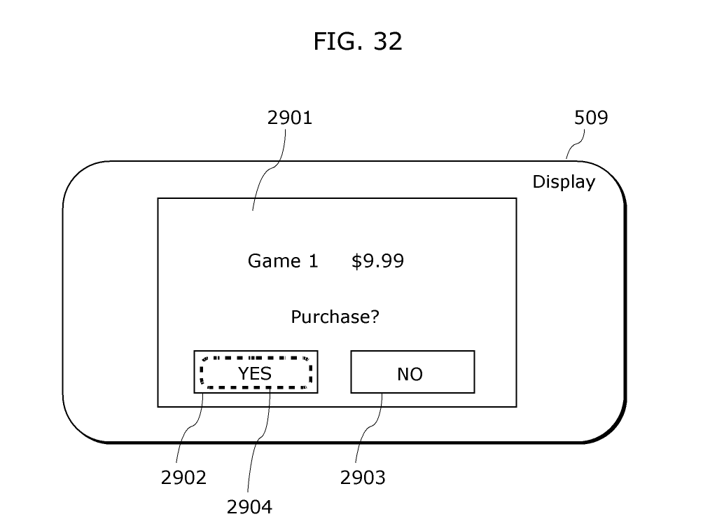

The purchasing unit 2302 outputs a dialog and asks the user whether or not to purchase (S2802). Here, an example of the display of a dialogue is shown in FIG. 32. A dialogue 2901 is displayed on the display 509 and, specifically, the name and price of the application to be purchased as well as a message inquiring about the purchase are displayed. Furthermore, two buttons, namely, a “YES” button 2902 and a “NO” button 2903 are displayed, and a cursor 2904 is placed on one of the two buttons.

When the user chooses to purchase, that is, when the cursor 2904 is on the “YES” button, and the user presses the OK button 1105, the purchasing unit 2302 communicates with the H/E and performs the purchasing (S2803). It is assumed that the purchasing is implemented through a method proprietary among the application of the Cable service operator, the H/E, and the billing system, as in the purchase of a PPV TV-program and the like. With this, the purchase of the same application and the purchase of a PPV, VOD TV-program can be implemented using the same method. Furthermore, there is the advantage of being able to share the same limits for the maximum purchase amount, maximum number of purchases, and so on. However, the present disclosure is not limited to this method.

When the purchasing is completed, the purchasing unit 2303 notifies the application activation unit 2303 of the completion of the purchasing (S2804). Furthermore, when the purchasing is completed, the purchasing unit 2303 also calls a setPurchased(true) method 2403f of the ExternalAppsAttribute class 2403 indicating the application “game 1” (row 2605 in FIG. 26), and updates the purchase status.

The subsequent process is the same as the process after S2706 in FIG. 29.

In this manner, when it is judged in the aforementioned judgment step that the first application program is not executable because it has not yet been purchased, the purchase processing unit 2302 performs the purchasing of the first application program (purchasing step).

As described above, since the purchase information of the AjaxCEapplication 1308 (specifically, the first application) can be obtained by the EPG 1302 (specifically, the second application), it becomes possible for the EPG 1302 (specifically, the second application) to appropriately judge, based on the purchase status, whether or not the AjaxCEapplication 1308 (specifically, the first application) can be activated. Furthermore, by using the purchasing process of the EPG application (specifically, the second application), unification of the purchasing process becomes possible.

In this manner, by unifying the purchasing process, the need to perform purchase-related setting, such as setting credit card information, for each middleware and application is eliminated, thus leading to reduced complication.

It should be noted that although the AjaxCE middleware 1307 and AjaxCE application 1308 are described here as examples of middleware and an external application of different types, the present disclosure can be applied even when other arbitrary middleware and applications are adopted as middleware and an external application of different types. Furthermore, the present disclosure is likewise applicable even when plural middleware are present.

### Application Example 2

Next, the operation of an application which performs parental lock management shall be described as application example 2.

In application example 1, by presenting the purchase status of the external application to the EPG application, the EPG application can appropriately activate the application in accordance with the purchase state. Furthermore, by using an existing purchasing process for the purchasing process of the application, unification becomes possible.

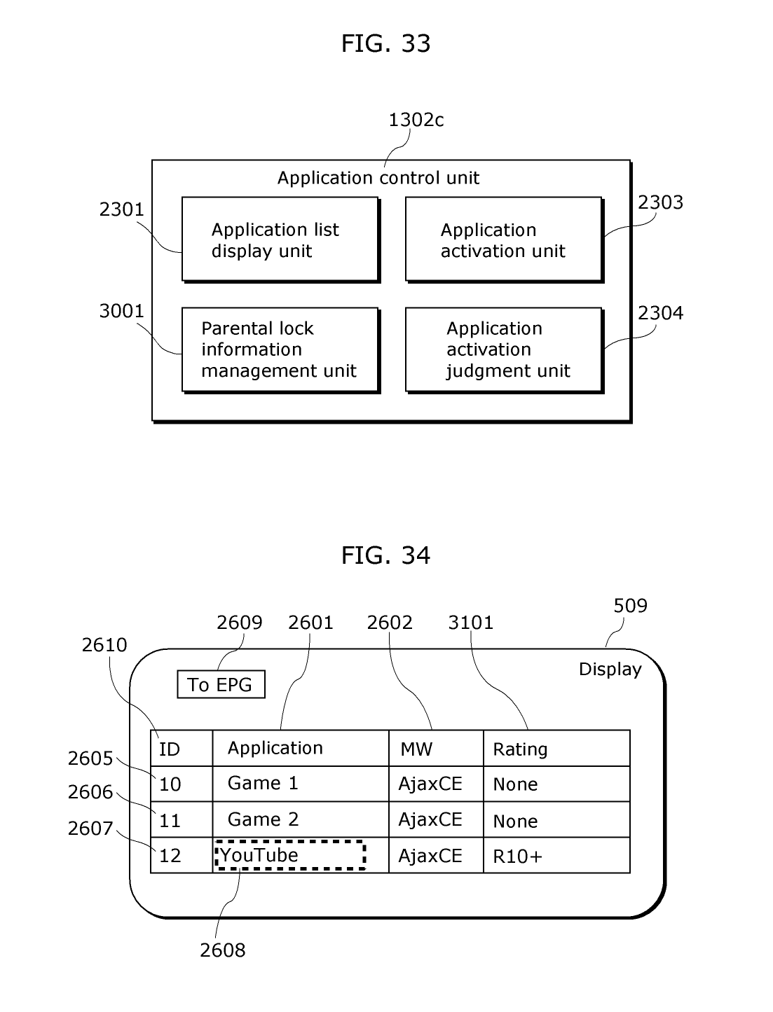

This application example particularly focuses on parental lock information. An example of the configuration of the application control unit 1302c in this application example is shown in FIG. 33. In this application example, the application control unit 1302c includes the application list display unit 2301, a parental lock information management unit 3001, the application activation unit 2303, and the application activation judgment unit 2304. In FIG. 33, the application list display unit 2301, the application activation unit 2303, and the application activation judgment unit 2304 have the same basic functions as that in FIG. 23, and thus their description shall be omitted. Description shall be centered on the points of difference from application example 1.

The parental lock information management unit 3001 is a storage unit which holds parental lock information set by the user.

In this application example, the application activation judgment unit 2304 obtains, from the parental lock information management information 3001, parental lock information indicating whether or not there is a parental lock for the first application program (here, AjaxCE application 1308), and judges whether or not the first application program (here, AjaxCE application 1308) is executable, based on the obtained parental lock information. More detailed description of these constituent elements is given below.

As shown in FIG. 33, in this application example, the application control unit 1302c includes the parental lock information management unit 3001 in place of the purchasing unit 2302. In general, the EPG application has a parental lock function and implements viewing restriction of TV-programs. The parental lock is set by the user. The parental lock information management unit 3001 holds the parental lock information set by the user. Now, assume that the application list display unit 2301 displays a list of applications. Since the processing for the display is the same as that in the sequence in FIG. 26, description thereof shall be omitted. An example of the display of an application list is shown in FIG. 34. In FIG. 34, a column 3101 shows pieces of rating information. The pieces of rating information are values obtained through the getRatingInfo( )method 2403b of the ExternalAppsAttribute class 2403. The rest of the entries are the same as those in FIG. 26, and thus their description shall be omitted.

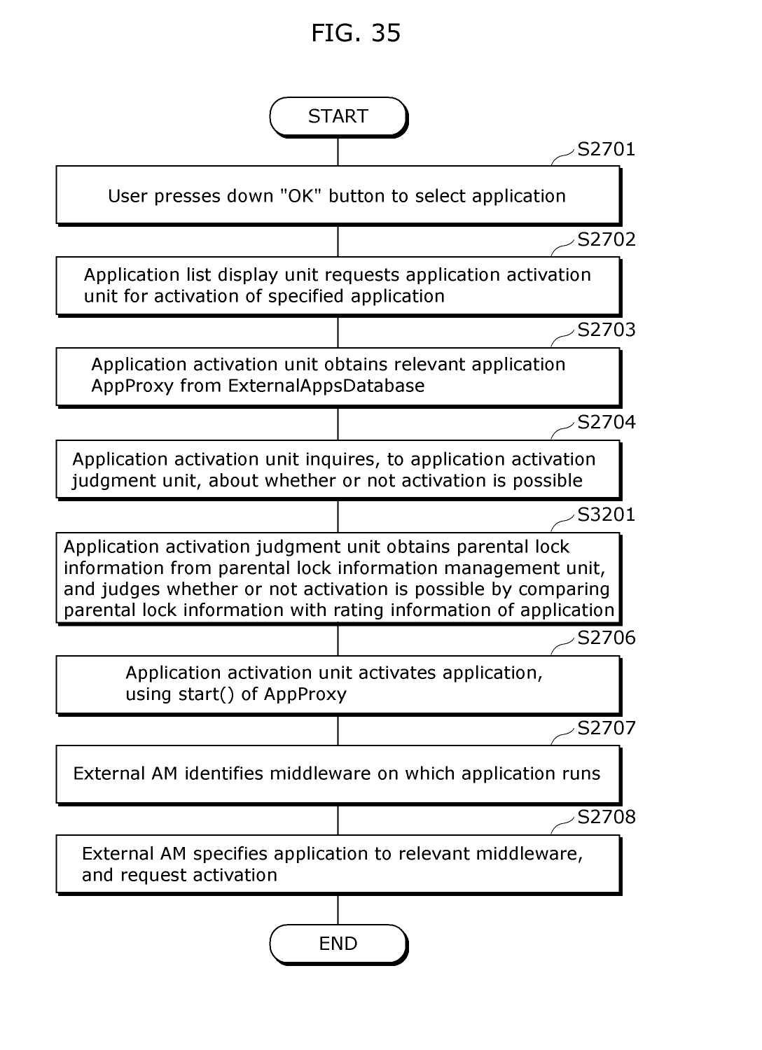

Here, the case where the user has selected the application “YouTube” (row 2607 in FIG. 26) shall be considered. The sequence for this case is shown in FIG. 35.

In the sequence in FIG. 35, steps S2701 to S2704 are the same as those in FIG. 29, and thus their description shall be omitted.

In step S3201, the application activation judgment unit 2304 obtains parental lock information from the parental lock information management unit 3001, and judges whether or not execution is possible by comparing the parental lock information and the rating information of the application “YouTube” (row 2607 in FIG. 26). Specifically, the application activation judgment unit 2304 obtains parental lock information indicating whether or not there is a parental lock for the first application program (here, the application “YouTube”) (obtaining step), and judges whether or not the first application program (here, the application “YouTube”) can be executed, based on the obtained parental lock information (judging step).

The rating information of the application “YouTube” (row 2607 in FIG. 26) can be obtained by calling the getRatingInfo( )method 2403b in the instance of the ExternalAppsAttribute class 2403 which holds the information of the application “YouTube” (row 2607 in FIG. 26).The application activation judgment unit 2304 compares the parental lock information and the rating information of the application “YouTube” (row 2607 in FIG. 26), and, when activation of the application is allowed, informs the application activation unit 2303 of such fact. The subsequent steps S2706 to S2708 are the same as those in FIG. 29, and thus their description shall be omitted.

As described above, according to application example 2, in the terminal apparatus 500 including the first application (AjaxCE application 1308) running on the first middleware (AjaxCE middleware 1307) and the second application (application control unit 1302c) which runs on the second middleware (Java VM 1303) and performs management of billing or parental locking, the second application receives an instruction to execute the first application (S2071), obtains parental lock information of the first application, and judges whether or not the first application is executable (S2702 to S3201), and activates the first application through the second middleware and the first middleware when it judges that execution is possible (S2706 to S2708).

With this, the judging for executability and the activation with respect to a first application program running on the first middleware is performed under the management of a second application program running on the second middleware. Therefore, management of parental locks for application programs running on respective different middleware is unified under the management by the second application program. As a result, the user can manage the parental locks for plural application programs running on different middleware through a single unified operation (for example, operation through an OCAP application).

In this manner, by disclosing the parental lock information of the external application (specifically, the first application) to the EPG application (specifically, the second application), the EPG application (specifically, the second application) can appropriately judge whether or not the external application (specifically, the first application) can be activated. Furthermore, by sharing the parental lock information used by the EPG application (specifically, the second application), unification of the parental lock information can also be performed at the same time.

By unifying management in this manner, the need for the user to set parental lock information for each middleware is eliminated, and thus saving time and effort and reducing setting errors.

Although the program execution method and the program execution apparatus according to the present disclosure have been described thus far based on the example, application example 1, and application example 2, the present disclosure is not limited to such examples. Those forms obtained by executing various modifications on the examples that can be conceived by a person of ordinary skill in the art without departing from the essence of the present disclosure as well as forms obtained by arbitrarily combining constituent elements of the exemplary examples are included in the present disclosure.

For example, although in the above-described example, a database (ExternalAppsDatabase defined by the External AM 1305h) which holds in advance the attributes of the applications running on the first middleware and the second middleware is referred to in order for the second application to obtain the attributes of the first application, the method for obtaining the attributes of the first application is not limited to such. Attributes such as billing information and parental lock information, and so on, may be obtained by having the second application inquire to the first application via the second middleware and the first middleware, and obtain a reply from the first application.

Specifically, the attributes of an application may be obtained through communication between applications, without referring to a database or in addition to a method which refers to a database.

Furthermore, although an OCAP application running on middleware (Java VM 1303) of the terminal apparatus performs integrated management of an application (AjaxCE application 1308) running on middleware (AjaxCE middleware 1307), a reversed integrated management is also possible. For example, the AjaxCE application 1308 may perform the execution control of the OCAP application, under its own billing and parental lock management. With this, the user can purchase all kinds of applications, perform parental lock management, and so on, using a common operation integrated through an arbitrary application.

Although only an exemplary example of the present disclosure has been described in detail above, those skilled in the art will readily appreciate that many modifications are possible in the exemplary example without materially departing from the novel teachings and advantages of the present disclosure. Accordingly, all such modifications are intended to be included within the scope of the present disclosure.

### INDUSTRIAL APPLICABILITY

The present disclosure can be used as an apparatus that controls the execution of application programs. In particular, since the present disclosure is capable of appropriately controlling applications running on different middleware and perform unified management of parental lock information, billing information, and billing management in an environment in which plural middleware are running, the present disclosure can be used as an apparatus which includes a function related to billing or parental lock, such as a digital broadcast receiving apparatus, a set top box, and so on.

1. A program execution method performed by an apparatus including an operating system, first middleware and second middleware that run on the operating system, a first application program that runs on the first middleware, and a second application program that runs on the second middleware and manages billing or a parental lock, said program executing method comprising:
receiving, by the second application program, an instruction to execute the first application program;
obtaining, by the second application program, billing information or parental lock information, the billing information indicating whether or not the first application program is already purchased, and the parental lock information indicating whether or not there is a parental lock for the first application program;
judging, by the second application program, whether or not the first application program is executable, based on the obtained billing information or the obtained parental lock information; and
activating, by the second application program, the first application program through the second middleware and the first middleware, when it is judged in said judging that the first application program is executable.

2. The program execution method according to claim 1, further comprising
purchasing, by the second application program, the first application program, when it is judged in said judging that the first application program is not executable because the first application program is not yet purchased.

3. The program execution method according to claim 1,
wherein, in said obtaining, the billing information or the parental lock information is obtained from a database in which attributes of application programs that run on the first middleware and the second middleware are held in advance, the application programs including the first application program and the second application program.

4. The program execution method according to claim 1,
wherein, in said obtaining, the billing information or the parental lock information is obtained by way of the second application program making an inquiry to the first application program and obtaining a reply from the first application program.

5. The program execution method according to claim 1,
wherein, in said activating:
the second application program notifies the second middleware of information for identifying the first application program that is judged as being executable; and
the second middleware identifies the first middleware as middleware on which the first application program runs, based on the information notified from the second application program, and requests the activation of the first application program to the identified first middleware.

6. A program execution apparatus comprising:
a processor; and
programs executed by said processor, said programs including:
an operating system;
first middleware that runs on said operating system;
second middleware that runs on said operating system;
a first application program that runs on said first middleware; and
a second application program that runs on said second middleware and manages billing and parental lock,
wherein said second application program includes:
an application list display unit configured to display application programs that run on at least said first middleware, and to receive an instruction to execute said first application program;
an application activation judgment unit configured to obtain billing information indicating whether or not said first application program is already purchased or parental lock information indicating whether or not there is a parental lock for said second application program, and to judge whether or not said first application program is executable, based on the obtained billing information or the obtained parental lock information; and
an application activation unit configured to activate said first application program through said second middleware and said first middleware, when said application activation judgment unit judges that said application program is executable.

7. The program execution apparatus according to claim 6, further comprising
a purchasing unit configured to purchase said first application program when said application activation judgment unit judges that said first application program is not executable because said first application program is not yet purchased.

8. An application program recorded on a non-transitory computer-readable recording medium, said application being the second application program included in the program execution apparatus according to claim 6.
